(19) United States
(12) Patent Application Publication
(10) Pub. No.: US 2019/0291400 A1
(43) Pub. Date: Sep. 26, 2019

(54) Multilayer Composites and Apparatuses and Methods for Their Making

(71) Applicant: ExxonMobil Chemical Patents Inc., Baytown, TX (US)

(72) Inventors: Alistair D. Westwood, Kingwood, TX (US); Galen C. Richeson, Humble, TX (US)

(21) Appl. No.: 16/373,942

(22) Filed: Apr. 3, 2019

Related U.S. Application Data
(62) Division of application No. 12/726,642, filed on Mar. 18, 2010.
(60) Provisional application No. 61/248,254, filed on Oct. 2, 2009.
(60) Provisional application No. 61/171,135, filed on Apr. 21, 2009.

(51) Int. Cl. B32B 27/32; B32B 7/05; B29C 65/00; B32B 3/28; B32B 27/40; B32B 27/36; B32B 27/34; B32B 27/30; B32B 27/12; B32B 25/14; B32B 25/10; B32B 23/10; B32B 5/26; B32B 5/24; B32B 5/22; B32B 5/04; B32B 5/02; D04H 3/16; D04H 3/007; D04H 1/56; D04H 1/4291; B29C 65/40; B29C 65/02; B29C 51/22; B29C 41/32; B29C 41/26

(52) U.S. Cl. CPC B32B 27/32; B29C 53/22; B29C 66/1122; B32B 3/28; B32B 27/40; B32B 27/36; B32B 27/34; B32B 27/308; B32B 27/12; B32B 25/14; B32B 25/10; B32B 23/10; B32B 5/26; B32B 5/24; B32B 5/22; B32B 5/04; B32B 5/024; B32B 5/022; D04H 3/16; D04H 3/007; D04H 1/56; D04H 1/4291; B29C 66/83513; B29C 66/83423; B29C 66/83413; B29C 66/438; B29C 65/40; B29C 65/028; B29C 51/225; B29C 41/32; B29C 41/26; Y10T 428/24612; B32B 7/05

(57) ABSTRACT

Provided are multi-beam meltblowing apparatuses having a ridged collecting surface, methods for making multilayer meltblown composites using such apparatuses, and multilayer meltblown composites made therefrom. Also provided are a multilayer composite comprising an elastic layer and at least one ridged layer and a method for making the multilayer composite.

### CROSS-REFERENCE TO RELATED APPLICATIONS

The present application is a Divisional Application of Ser. No. 12/726,642 filed Mar. 18, 2010, which claims priority to and the benefit of U.S. Ser. No. 61/248,254, filed Oct. 2, 2009; U.S. Ser. No. 12/723,336, filed Mar. 12, 2010; U.S. Ser. No. 12/723,317, filed Mar. 12, 2010; U.S. Ser. No. 12/566,410, filed Sep. 24, 2009; U.S. Ser. No. 12/566,434, filed Sep. 24, 2009; U.S. Ser. No. 61/156,078, filed Feb. 27, 2009; and U.S. Ser. No. 61/171,135, filed Apr. 21, 2009, each of which is herein incorporated by reference in its entirety.

This application is related to U.S. Ser. No. 12/566,564, filed Sep. 24, 2009; U.S. Ser. No. 61/101,341, filed Sep. 30, 2008; U.S. Ser. No. 12/271,526, filed Nov. 14, 2008; and U.S. Ser. No. 61/157,524, filed Mar. 4, 2009, each of which is herein incorporated by reference in its entirety.

### FIELD OF THE INVENTION

This application relates to a multilayer composite and an apparatus and a method for making it. More particularly, this application relates to a multilayer composite comprising an elastic layer and a ridged layer and a method for making the multilayer composite. This application also relates in particular to a multi-beam meltblowing apparatus having a ridged collecting surface, a method for making multilayer meltblown composites using the apparatus, and multilayer meltblown composites made therefrom.

### DESCRIPTION OF THE RELATED ART

Elastomers are useful as elastic nonwovens or films in applications such as waistbands, side panels, closure systems, and baby diapers, adult incontinence and personal hygiene garments. Most of these elastic closures are constructed with facing layers that include a nonwoven material that is plastic in properties and provides aesthetic attributes such as touch and feel. Examples of such include those disclosed in U.S. Publication No. 2008/0045917. The plastic facing layers sandwich the elastic (intermediate) layer, which possesses a rubbery feel that is typically not desirable for skin contact.

Existing products include complex laminates of an elastic film, for example, a styrenic block copolymer (“SBC”) or polyurethane as the elastic film that can have polyolefin skins coextruded onto the film to prevent blocking, and nonwovens in order to provide the correct aesthetic (a soft, fluffy, cushion-like texture) and in certain constructions a hot melt glue layer to bond the nonwoven to either side of the elastic film. These types of constructions, once formed, typically require activation. The term “activation” refers to a process where an elastic laminate is physically stretched in order to remove the constraint present due to the method used to construct the laminate. Typically, the constraint is due to the inelastic components such as the polyolefin skin layers, adhesives, and nonwoven facing layers. The mechanical stretching or activation process stretches or breaks the non-elastic components to remove the constraint, and creates an elastic composite controlled by the elastic film. The mechanical stretching, or activation, typically results in a laminate that, once stretched, can recover up to but not beyond the amount of stretch applied during the activation process.

Furthermore, such composites typically require the film to be apertured or perforated to make the laminates breatheable. This process involves the controlled puncturing/tearing of the film with the associated concerns for film failure and increased scrap rates.

Work in this area has been discussed in U.S. Pat. Nos. 5,272,003; 5,366,782; 6,075,179; 6,342,565; and 7,026,404; U.S. Publication Nos. 2008/0199673; 2008/0182116; 2008/0182940; 2008/0182468; 2006/0172647; 2005/0130544; 2005/0106978; and PCT Patent Application Publication No. WO 2008/094337.

Patterned nonwoven webs and methods for making them have been described in U.S. Pat. Nos. 4,103,058; 4,177,312; 4,252,590; and 4,042,740.

There is a need for elastic nonwoven composites having the desired aesthetic qualities and that do not require mechanical activation. There is also a need for new apparatuses and methods for making such multilayer composites.

### SUMMARY OF THE INVENTION

Provided are apparatuses and methods for making multilayer composites, and multilayer composites having a ridged layer.

In one embodiment, the invention encompasses an apparatus for making a multilayer composite, comprising: a first extruder; a first die connected to the first extruder for producing a first layer; a second extruder; a second die connected to the second extruder for producing a second layer; an intermediate extruder; an intermediate die connected to the intermediate extruder for producing an intermediate layer and positioned such that the intermediate layer is between the first and second layers; a first collecting surface positioned to collect the first layer; a second collecting surface positioned to collect the second layer, wherein the first and second collecting surfaces create a nip through which the first layer, the second layer, and the intermediate layer are passed to form a multilayer composite, and wherein at least one of the first and second collecting surfaces is ridged.

In one embodiment, the invention encompasses an apparatus for making a multilayer composite, comprising: a first extruder; a first die connected to the first extruder for producing a first layer; a second extruder; a second die connected to the second extruder for producing a second layer; a ridged first collecting surface positioned to collect the first layer; a ridged second collecting surface positioned to collect the second layer, wherein the first and ridged second collecting surfaces create a nip through which the first layer and the second layer are passed to form a multilayer composite.

In one embodiment, the invention encompasses an apparatus for making a multilayer composite, comprising: a first extruder; a first die connected to the first extruder for producing a first layer; a second extruder; a second die connected to the second extruder for producing a second layer; an intermediate extruder; an intermediate die connected to the intermediate extruder for producing an intermediate layer and positioned such that the intermediate layer is between the first and second layers; and a ridged collecting surface positioned to collect the first layer, the second layer, and the intermediate layer to form a multilayer composite.

In another embodiment, the invention encompasses a method for forming a multilayer composite comprising the steps of: (a) producing a first layer using a first die; (b) producing a second layer using a second die; (c) producing an intermediate layer using an intermediate die; (d) providing a first collecting surface positioned to collect the first layer and a second collecting surface positioned to collect the second layer, wherein the first and second collecting surfaces create a nip, and wherein at least one of the first and second collecting surfaces is ridged; (e) passing the first layer, the second layer, and the intermediate layer through the nip, wherein the intermediate layer is between the first layer and the second layer; and (f) forming a multilayer composite.

In one embodiment, the invention encompasses a method for forming a multilayer composite comprising the steps of: (a) producing a first layer using a first die; (b) producing a second layer using a second die; (c) providing a ridged first collecting surface positioned to collect the first layer and a ridged second collecting surface positioned to collect the second layer, wherein the first and ridged second collecting surfaces create a nip; (d) passing the first layer and the second layer through the nip; and (e) forming a multilayer composite.

In one embodiment, the invention encompasses a method for forming a multilayer composite comprising the steps of: (a) producing a first layer using a first die; (b) producing a second layer using a second die; (c) producing an intermediate layer using an intermediate die; (d) providing a ridged collecting surface positioned to collect the first layer, the second layer, and the intermediate layer to form a multilayer composite wherein the intermediate layer is between the first layer and the second layer; and (e) forming the multilayer composite.

In another embodiment, the invention encompasses a multilayer composite comprising: (a) a ridged first layer having an allowable elongation of at least about 20%; (b) an intermediate layer comprising an elastic resin; and (c) a ridged second layer having an allowable elongation of at least about 20%, wherein the intermediate layer is between the ridged first layer and the ridged second layer.

In another embodiment, the invention encompasses a method for forming a multilayer composite comprising: (a) providing a ridged first layer having an allowable elongation of at least about 20%; (b) providing an intermediate layer comprising an elastic resin; (c) providing a ridged second layer having an allowable elongation of at least about 20%; and (d) contacting the intermediate layer with the ridged first layer and the ridged second layer to form a multilayer composite, wherein the intermediate layer is between the ridged first layer and the ridged second layer.

### BRIEF DESCRIPTION OF THE DRAWINGS

So that the recited features of the invention can be understood in detail, a more particular description is provided by reference to embodiments of the invention, some of which are illustrated in the appended drawings. These drawings illustrate only certain embodiments of this invention, and are not to be considered limiting of its scope.

FIG. 1 depicts a schematic view of an illustrative meltblowing system for making a multilayer meltblown composite.

FIG. 2 depicts an enlarged schematic view of an illustrative die assembly.

FIG. 3 depicts a schematic view of an illustrative meltblowing system for making a multilayer meltblown composite. As depicted in this embodiment, the dies and collecting surfaces can be vertically disposed.

FIG. 4 depicts a schematic of another illustrative meltblowing system for making a multilayer meltblown composite. As depicted in this embodiment, the dies and collecting surfaces can be horizontally disposed.

FIG. 5 depicts a schematic of another illustrative meltblowing system for making a multilayer meltblown composite. As depicted in this embodiment, the collecting surfaces can be vertically disposed and the dies can be arranged anywhere about the collecting surfaces.

FIG. 6 depicts a schematic of yet another illustrative meltblowing system for making a multilayer meltblown composite. As depicted in this embodiment, the collecting surfaces can be vertically disposed and the dies can be arranged anywhere about the collecting surfaces. One or more facing layers can also be introduced to collecting surfaces and fibers meltblown thereon.

FIG. 7 depicts a schematic of still another illustrative meltblowing system for making a multilayer meltblown composite. As depicted in this embodiment, the collecting surfaces can be horizontally disposed and the dies can be arranged anywhere about the collecting surfaces. Two or more dies can also be used to form the intermediate layer.

FIG. 8 depicts a schematic of yet another illustrative meltblowing system for making a multilayer meltblown composite. As depicted in this embodiment, the collecting surfaces can be horizontal belts or conveyors, and the dies can be arranged anywhere about the collecting surfaces.

FIG. 9 depicts a schematic of still yet another illustrative meltblowing system for making a multilayer meltblown composite. As depicted, a single collecting surface can be used, and the dies can be arranged anywhere about the collecting surfaces.

FIGS. 10 (a)-(c) depict illustrative types of ridged collecting surfaces, according to one or more embodiments described. FIG. 10(a) depicts an embodiment where ridged collecting surfaces 380A and 380B are rods having a series of vanes forming ridges. FIG. 10(b) depicts an embodiment where ridged collecting surfaces 380A and 380B are a series of parallel plates forming ridges. FIG. 10(c) depicts an embodiment where ridged collecting surfaces 380A and 380B are corrugated surfaces on a set of counter-rotating vacuum drums. Each of these illustrative types of ridged collecting surfaces can be combined with the apparatuses exemplified herein.

FIG. 11 depicts illustrative types of the shapes of ridges on the collecting surfaces, according to one or more embodiments described.

FIGS. 12 (a)-(f) depict illustrative pairs of ridged collecting surfaces, according to one or more embodiments described. FIG. 12(a) depicts a pair of zigzag shaped ridges in the male-female configuration. FIG. 12(b) depicts a pair of zigzag shaped ridges in the female-female configuration. FIG. 12(c) depicts a pair of sinusoidal shaped ridges in the male-female configuration. FIG. 12(d) depicts a pair of sinusoidal shaped ridges in the female-female configuration. FIG. 12(e) depicts a pair of trapezoidal shaped ridges in the male-female configuration. FIG. 12(f) depicts a pair of trapezoidal shaped ridges in the female-female configuration.

FIG. 13 is a three-dimensional rendering of an illustrative multilayer composite, according to one or more embodiments described.

FIGS. 14 (a)-(c) depict illustrative multilayer composites produced from pairs of ridged collecting surfaces, according to one or more embodiments described. FIG. 14(a) depicts a multilayer composite produced from a pair of zigzag shaped ridges in the male-female configuration with complete contact between the first and second layers and the intermediate layer. FIG. 14(b) depicts a multilayer composite produced from a pair of zigzag shaped ridges in the female-female configuration with partial contact between the first or second layer and the intermediate layer. FIG. 14(c) depicts a multilayer composite produced from a pair of trapezoidal shaped ridges in the female-female configuration with complete contact between the first and second layers and the intermediate layer at the contact surfaces only.

FIG. 15(a) identifies the face length, horizontal peak-to-valley, and vertical peak-to-valley distances referred to herein for zigzag-shaped ridges. FIG. 15(b) illustrates the relationship between actual distance versus projected distance for a ridged layer having zigzag-shaped ridges.

### DETAILED DESCRIPTION OF PREFERRED EMBODIMENTS

A detailed description will now be provided. Headings used herein are for reference only and are not intended to limit any aspect of the invention. Depending on the context, references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples. However, the inventions are not limited to these embodiments, versions or examples, which are included to enable a person having ordinary skill in the art to make and use the inventions.

### Multi-Beam Apparatus

In one embodiment, the invention encompasses an apparatus for making a multilayer composite, comprising: a first extruder; a first die connected to the first extruder for producing a first layer; a second extruder; a second die connected to the second extruder for producing a second layer; an intermediate extruder; an intermediate die connected to the intermediate extruder for producing an intermediate layer and positioned such that the intermediate layer is between the first and second layers; a first collecting surface positioned to collect the first layer; and a second collecting surface positioned to collect the second layer, wherein the first and second collecting surfaces create a nip through which the first layer, the second layer, and the intermediate layer are passed to form a multilayer composite, and wherein at least one of the first and second collecting surfaces is ridged.

In one embodiment, the invention encompasses an apparatus for making a multilayer composite, comprising: a first extruder; a first die connected to the first extruder for producing a first layer; a second extruder; a second die connected to the second extruder for producing a second layer; a ridged first collecting surface positioned to collect the first layer; and a ridged second collecting surface positioned to collect the second layer, wherein the first and ridged second collecting surfaces create a nip through which the first layer and the second layer are passed to form a multilayer composite.

In a preferred embodiment, the first and second collecting surfaces are both ridged. Preferably, at least one of the ridged first and second collecting surfaces have an average peak-to-valley vertical distance of at least about 2 mm or about 2 mm to about 12 mm. Also preferably, the ridged first and second collecting surfaces are out of phase with one another or in the female-female configuration. Preferably, at least one of the first and second collecting surfaces have ridges in a flattened-tip shape.

In one embodiment, the apparatus further comprises a third extruder and a third die for producing a third layer, wherein the third die is connected to the third extruder and positioned such that the first layer, the second layer, the third layer, and the intermediate layer pass through the nip to form a multilayer composite.

In one embodiment, the apparatus further comprises a fourth extruder and a fourth die for producing a fourth layer, wherein the fourth die is connected to the fourth extruder and positioned such that the first layer, the second layer, the third layer, the fourth layer, and the intermediate layer pass through the nip to form a multilayer composite.

In some embodiments, the first and second collecting surfaces are counter-rotating drums. In other embodiments, at least one of the first and second collecting surfaces is a series of parallel plates forming ridges. In some embodiments, at least one of the first and second collecting surfaces is a rod having a series of vanes forming ridges.

The invention also encompasses multilayer composites prepared by an apparatus of the invention.

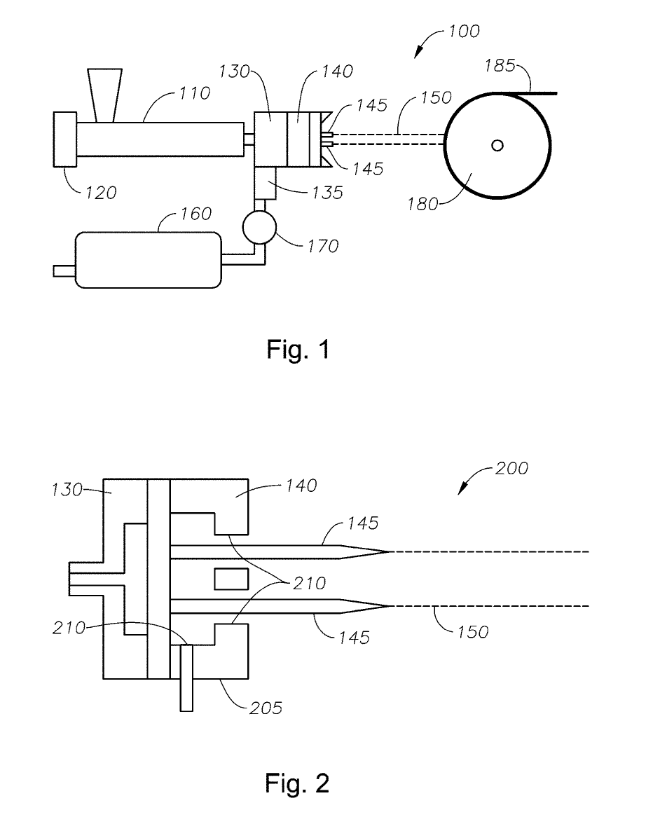

FIG. 1 depicts a schematic view of an illustrative meltblowing system or arrangement 100 for making the multilayer meltblown composite, according to one or more embodiments. The system 100 includes at least one extruder 110, and may include a motor 120 to maintain melt pressure within the system 100. The extruder 110 can be coupled to at least one die block or array die 130 that is coupled to a spinneret portion or spinneret 140. The die block 130 is also coupled to at least one air manifold 135 for delivering high pressure air to the spinneret portion 140 of the die block 130. The spinneret 140 includes a plurality of spinning nozzles 145 through which molten polymer is extruded and simultaneously attenuated with high-velocity air to form filaments, or fibers 150. The spinning nozzles 145 are preferably circular, die capillaries. Preferably, the spinneret 140 has a nozzle density that ranges from about 20, 30, or 40 holes/inch to about 200, 250, or 320 holes/inch. In one embodiment, each nozzle 145 has an inside diameter ranging of from about 0.05 mm, 0.10 mm, or 0.20 mm to about 0.80 mm, 0.90 mm, or 1.00 mm.

In the die spinneret 140, the molten threads or filaments converge with a hot, high velocity, gas stream (e.g., air or nitrogen) to attenuate the filaments of molten thermoplastic material to form the individual fibers 150. The temperature and flow rate of the attenuating gas stream can be controlled using a heat exchanger 160 and air valve 170. The diameters of the filaments can be reduced by the gas stream to a desired size. Thereafter, the meltblown fibers 150 are carried by the high velocity gas stream and are deposited on a collecting surface 180 to form at least one web 185 of meltblown fibers. The collecting surface 180 can be an exterior surface of a vacuum drum, for example.

FIG. 2 depicts an enlarged schematic view of an illustrative die assembly 200, according to one or more embodiments. The die assembly 200 includes the die block 130 and the spinneret assembly 140. As depicted, the air (“primary air”) is provided through the primary air nozzle 210 located at least on a side of the die spinneret 140. The die block 130 can be heated using the primary air, a resistive heating element, or other known device or technique (not shown), to prevent the die block 130 from becoming clogged with solidifying polymer as the molten polymer exits and cools. The air also draws, or attenuates, the melt into fibers. Secondary, or quenching, air can also be provided. Primary air flow rates typically range from about 1 to 30 or 5 to 50 standard cubic feet per minute per inch of die width (SCFM/inch). In certain embodiments, the primary air pressure in the meltblown process typically ranges from a low of about 2 psig (13.8 kPa), 3 psig (20.7 kPa), 5 psig (34.5 kPa), or 7 psig (48.3 kPa) to about 10 psig (68.9 kPa), 15 psig (103.4 kPa), 20 psig (137.9 kPa), or 30 psig (206.8 kPa) at a point in the spinneret assembly 140 just prior to exit. Primary air temperatures are typically within the range from about 150° C., 200° C., or 230° C. to about 300° C., 320° C., or 350° C.

The melting temperature (Tm) of the resins can range from about 50° C. to 300° C. In yet other embodiments, the melting temperature is at least 50° C. and less than 150° C., 200° C., 220° C., 230° C., 250° C., 260° C., 270° C., 280° C., 290° C., 300° C., 310° C., or 320° C. The resin can be formed into fibers at a melt pressure from greater than about 500 psi (3.4 MPa) or 750 psi (5.2 MPa) or 1,000 psi (6.9 MPa) or 2,000 psi (13.8 MPa), or within the range from about 500 psi (3.5 MPa) or 750 psi (5.2 MPa) to about 1,000 psi (6.9 MPa) or 2,000 psi (13.8 MPa) or 2,500 psi (17.3 MPa).

Expressed in terms of the amount of composition flowing per capillary hole per unit of time, throughputs for the manufacture of meltblown fabrics using the compositions described herein are typically within the range from about 0.1, 0.2, 0.3, or 0.5 to about 1.0, 1.5, 2.0, or 3.0 grams per hole per minute (ghm). In some instances, polymer throughput can be about 0.25, 0.5, or 1.0 to about 4, 8, or 12 lbs/inch/hour (PIH), or about 0.05, 0.09, or 0.2 to about 0.7, 1, or 2.1 kg/cm/hour. For a die having 30 holes per inch (12 holes per cm), polymer throughput is typically about 0.4, 0.8, 1.2, or 2.0 to about 4, 6, 8, or 12 PIH, or about 0.07, 0.1, 0.2, or 0.4 to about 0.7, 1, 1.4, or 2 kg/cm/hour.

Because such high temperatures can be used, a substantial amount of heat is desirably removed from the fibers in order to quench, or solidify, the fibers leaving the nozzles. Although not shown, cold gases of air or nitrogen can be used to accelerate cooling and solidification of the meltblown fibers. In particular, secondary, or quenching, air may be used to cool meltblown fibers. Also, an additional, cooler pressurized quench air may be used and can result in even faster cooling and solidification of the fibers. Through the control of air and array die temperatures, air pressure, and polymer feed rate, the diameter of the fiber formed during the meltblown process may be regulated.

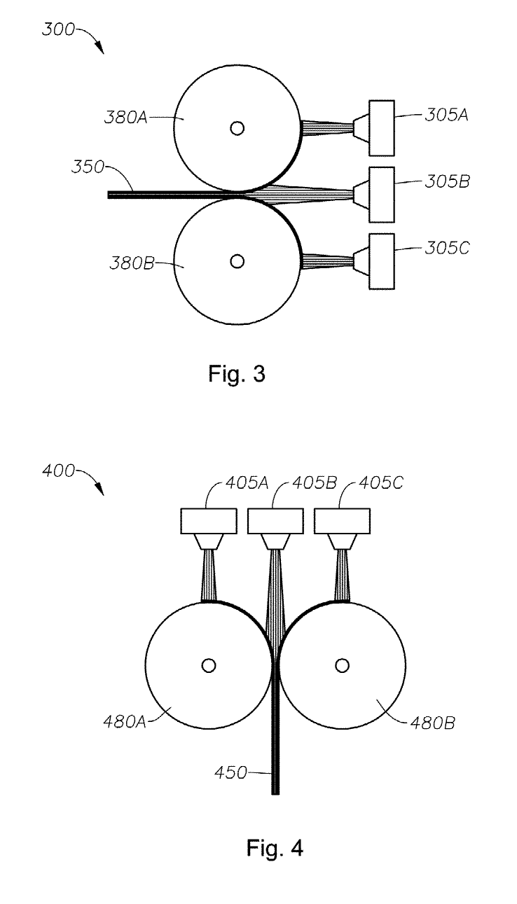

FIGS. 3 through 8 depict schematics of various illustrative meltblowing systems or arrangements that can be used to make multilayer composites, according to one or more embodiment described. FIG. 3, for example, depicts a schematic of an illustrative meltblowing system 300 for making a multilayer meltblown composite 350. The meltblowing system 300 can include three or more vertically arranged dies, a first die 305A, an intermediate die 305B, and second die 305C. Each die 305A, 305B, 305C can be similar to the die 200 discussed and described above with reference to FIG. 2. Any resin or combination of resins can be blown through any given die 305A, 305B, 305C, where the first die 305A provides a first layer, the intermediate die 305B provides an intermediate layer, and the second die 305C provides a second layer.

The meltblowing system 300 can further include two or more collecting surfaces, a first collecting surface 380A and a second collecting surface 380B, that are vertically aligned. Each collecting surface 380A, 380B can be similar to the collection drum 180 depicted and described above with reference to FIG. 1. The collecting surfaces 380A and 380B can be adjacent one another such that a desired gap (“nip”) is defined there between. As depicted, fibers from each die 305A, 305B, 305C are horizontally directed toward and collected on the collecting surfaces 380A, 380B to form a three layer fabric composite 350. The dies 305A, 305B, 305C can be independently movable with respect to one another. The dies 305A, 305B, 305C can also be independently movable with respect to the collecting surfaces 380A, 380B to vary the die-to-collector distance (“DCD”).

FIG. 4 depicts a schematic of another illustrative meltblowing system 400 for making a multilayer meltblown composite 450, according to one or more embodiments. The meltblowing system 400 can include three or more horizontally arranged dies, a first die 405A, an intermediate die 405B, and a second die 405C, and horizontally aligned first collecting surface 480A and second collecting surface 480B. Each die 405A, 405B, 405C can be similar to the die 200 discussed and described above with reference to FIG. 2. Each collecting surface 480A, 480B can be similar to the collection drum 180, as depicted and described above with reference to FIG. 1. The dies 405A, 405B, 405C can be independently movable with respect to one another. The dies 405A, 405B, 405C can also be independently movable with respect to the collecting surfaces 480A, 480B to vary the DCD.

Any resin or combination of resins can be vertically extruded through any given die 405A, 405B, 405C to provide a multilayer composite having first and second facing layers disposed about an intermediate layer, as described herein. As depicted, fibers from each die 405A, 405B, 405C are directed toward and collected on the collecting surfaces 480A, 480B to form a three layer fabric composite 450.

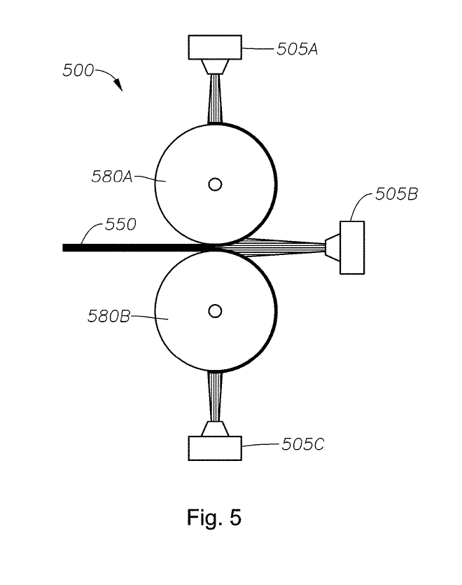

As used herein, the term “intermediate” with respect to a layer means that the layer is anywhere between any two given layers; an “intermediate layer” is not limited to the centermost layer or any particular placement in a multilayer composite so long as it is sandwiched by the two given layers. The term “intermediate” with respect to a die or an extruder is merely used, for purposes of convenience, as an identifier of the die or extruder in connection with the layer produced therefrom (e.g., an intermediate die for producing an intermediate layer); an “intermediate die” is not limited by any particular position of the die with respect to any other dies, e.g., it need not be positioned along the same axis as the other dies (see, e.g., FIGS. 5-7), so long as it produces the intermediate layer being described.

FIG. 5 depicts a schematic of another illustrative meltblowing system 500 for making a multilayer meltblown composite 550, according to one or more embodiments. The meltblowing system 500 can include three or more dies, a first die 505A, an intermediate die 505B, and a second die 505C, to provide a multilayer composite having first and second facing layers disposed about an intermediate layer, as described herein. Each die 505A, 505B, 505C can be similar to the die 200 discussed and described above with reference to FIG. 2. The meltblowing system 500 can further include two or more collecting surfaces, a first colleting surface 580A and a second collecting surface 580B that are vertically aligned. Each collecting surface 580A, 580B can be similar to the collection drum 180, as depicted and described above with reference to FIG. 1.

The first die 505A and the second die 505C can be vertically aligned with respect to one another and located on opposing sides of the collecting surfaces 580A, 580B. The intermediate die 505B can be located intermediate the first and second dies 505A, 505C or provide a three layer fabric composite 550.

Any resin or combination of resins can be extruded through any given die 505A, 505B, 505C to provide the multilayer composite 550. The dies 505A, 505B, 505C can be independently movable with respect to one another. The dies 505A, 505B, 505C can also be independently movable with respect to the collecting surfaces 580A, 580B to vary the DCD.

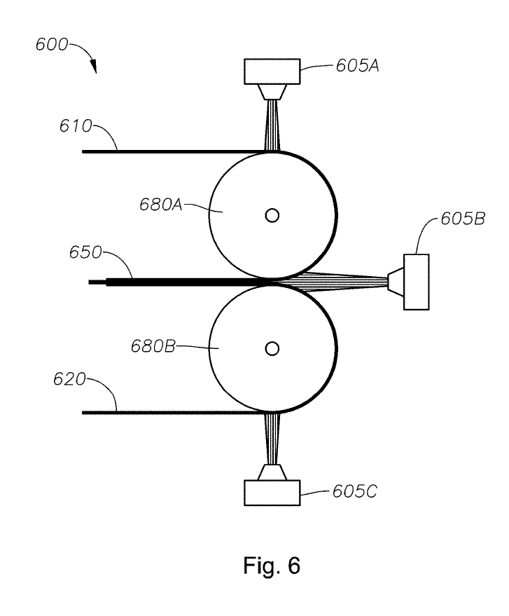

FIG. 6 depicts a schematic of yet another illustrative meltblowing system 600 for making a multilayer meltblown composite 650, according to one or more embodiments. The meltblowing system 600 can include three or more dies, a first die 605A, an intermediate die 605B, and a second die 605C. Each die 605A, 605B, 605C can be similar to the die 200 discussed and described above with reference to FIG. 2. The meltblowing system 600 can further include two or more collecting surfaces, a first collecting surface 680A and second collecting surface 680B that are vertically aligned. Each collecting surface can be similar to the collection drum 180, as depicted and described above with reference to FIG. 1. Like the embodiment of FIG. 5, the first die 605A and the second die 605C can be vertically aligned with respect to one another and located on opposing sides of the collecting surfaces 680A, 680B while the intermediate die 605B can be located intermediate the first and second dies 605A, 605C.

A first facing layer 610 can be introduced to the meltblowing system 600 via the first collecting surface 680A. A second facing layer 620 can also be introduced to the meltblowing system 600 via the second collecting surface 680B. As shown, the collecting surfaces 680A, 680B provide facing layers 610, 620, respectively, on which the fibers blown from the dies 605A, 605B, 605C, respectively, are collected. Accordingly, the resulting multilayer composite has at least five layers.

Any resin or combination of resins can be extruded through any given die 605A, 605B, 605C. The dies 605A, 605B, 605C can be independently movable with respect to one another. The dies 605A, 605B, 605C can also be independently movable with respect to the collecting surfaces 180A, 180B and/or the facing layers 610, 620 disposed on the collecting surfaces 180A, 180B.

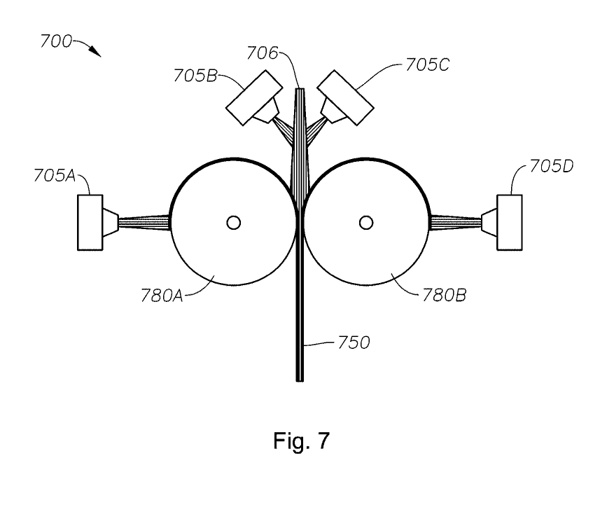

FIG. 7 depicts a schematic of still another illustrative meltblowing system 700, according to one or more embodiments. The meltblowing system 700 can include four or more dies, a first die 705A, a first intermediate die 705B, a second intermediate die 705C, and a second die 705D. Each die 705A, 705B, 705C, 705D can be similar to the die 200 discussed and described above with reference to FIG. 2. The meltblowing system 700 can further include two or more collecting surfaces, a first collecting surface 780A and a second collecting surface 780B, that are horizontally aligned. Each collecting surface 780A, 780B can be similar to the collection drum 180, as depicted and described above with reference to FIG. 1.

At least two dies, such as the first die 705A and the second die 705D, can be horizontally aligned with respect to one another and located on opposing sides of the collecting surfaces 780A, 780B. At least two dies, such as the first intermediate die 705B and the second intermediate die 705C, can be located intermediate the first die 705A and the second die 705D. The dies 705A, 705B, 705C, 705D can be independently movable with respect to one another. The dies 705A, 705B, 705C, 705D can also be independently movable with respect to the collecting surfaces 180A, 180B to vary the DCD.

Any resin or combination of resins can be extruded through any given die 705A, 705B, 705C, 705D to provide the multilayer composite 750. As depicted, fibers from each die 705A, 705B, 705C, 705D are directed toward and collected on the collecting surfaces 780A, 780B to form a three layer fabric composite 750. The middle or intermediate layer, or the intermediate layer, can include a mixture of fibers produced from the first intermediate die 705B and the second intermediate die 705C. An additional layer of resin or one or more additives or particulates can be sprayed or otherwise introduced through nozzle 706 located between the intermediate dies 705B and 705C.

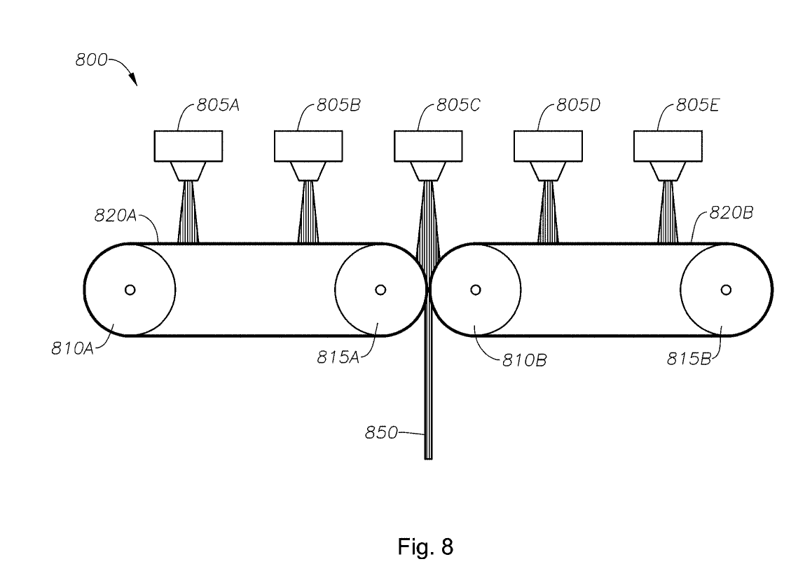

FIG. 8 depicts a schematic of yet another illustrative meltblowing system 800, according to one or more embodiments. The meltblowing system 800 can include five or more dies, a first die 805A, an intermediate die 805C, a second die 805E, a third die 805B, and a fourth die 805D. Each die 805A, 805B, 805C, 805D, 805E can be similar to the die 200 discussed and described above with reference to FIG. 2. The meltblowing system 800 can further include two or more horizontally arranged collecting surfaces, a first collecting surface 820A and a second collecting surface 820B. As depicted, the first collecting surface 820A can be a conveyor belt disposed about and moved by two horizontally aligned drums 810A and 815A. Similarly, the second collecting surface 820B can be a conveyor belt disposed about and moved by two horizontally aligned drums 810B, 815B. The collecting surfaces 820A, 820B can be adjacent one another such that a nip is defined there between.

Each die 805A, 805B, 805C, 805D, 805E can be horizontally aligned above the collecting surfaces 820A, 820B or aligned in other spatial orientation. The dies 805A, 805B, 805C, 805D, 805E can be independently movable with respect to one another. The dies 805A, 805B, 805C, 805D, 805E can also be independently movable with respect to the collecting surfaces 820A, 820B.

The collecting surfaces 820A, 820B can provide a collecting surface for fibers produced from the dies 805A, 805B, 805C, 805D, 805E. Any resin or combination of resins can be extruded through any given die 805A, 805B, 805C, 805D, 805E. As depicted, fibers from each die 805A, 805B, 805C, 805D, 805E are directed toward and collected on the collecting surfaces 820A and 820B to form a five layer fabric composite 850.

In one embodiment, the invention encompasses an apparatus for making a multilayer composite, comprising: a first extruder; a first die connected to the first extruder for producing a first layer; a second extruder; a second die connected to the second extruder for producing a second layer; an intermediate extruder; an intermediate die connected to the intermediate extruder for producing an intermediate layer and positioned such that the intermediate layer is between the first and second layers; and a ridged collecting surface positioned to collect the first layer, the second layer, and the intermediate layer to form a multilayer composite.

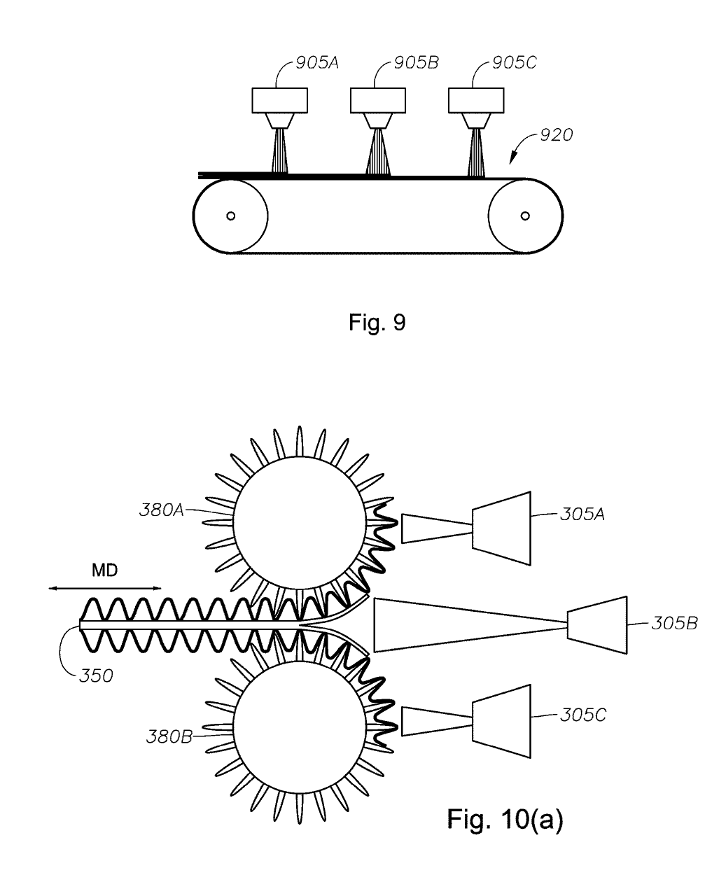

FIG. 9 depicts a schematic of an illustrative meltblowing system 900 for making a multilayer meltblown composite, according to one or more embodiments described. As depicted, a single collecting surface 920 can be used, and a first die 905A, an intermediate die 905B, and a second die 905C can be arranged anywhere about the collecting surfaces.

Referring to any system or arrangement described above 100, 200, 300, 400, 500, 600, 700, 800, or 900 with regard to FIGS. 1 through 9 or elsewhere herein, the first layer, intermediate layer, and second layer may be passed through the nip between at least one unheated or heated ridged collecting surface(s), with light pressure applied thereon, as another construction (e.g., an extensible layer) is added to form a multilayer composite.

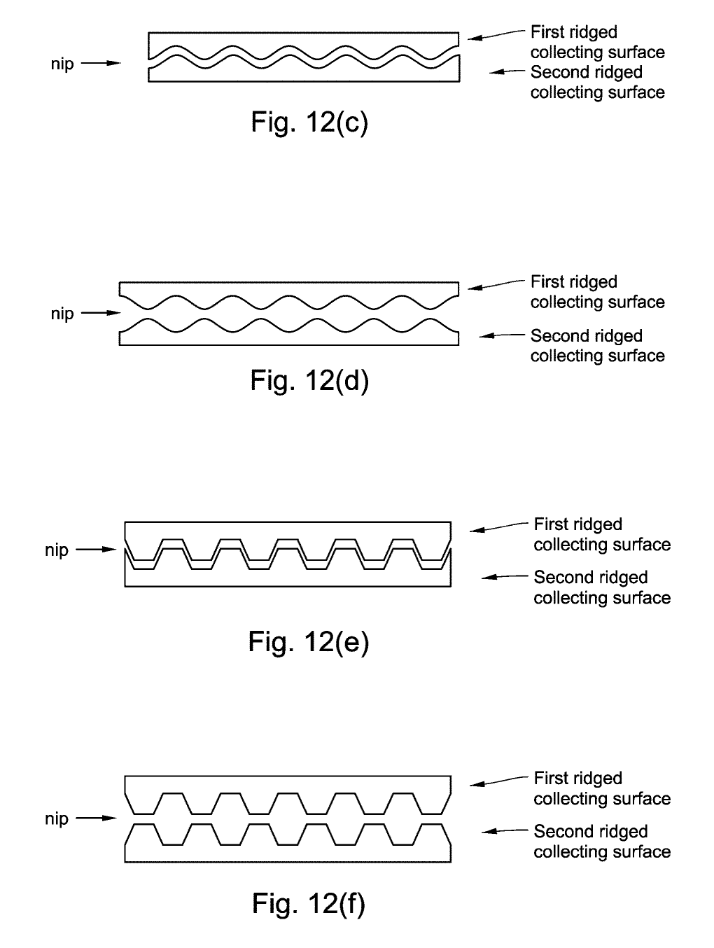

In one embodiment, at least one of the collecting surfaces is “ridged”, i.e., having a plurality of alternating parallel ridges and grooves. A ridged surface is not limited to any particular rigidity. The ridges and grooves can run circumferentially around the width or longitudinally around the length of a collecting surface, which may include a roll, drum, or rod. The ridges and grooves are not limited to any particular shape and can be, for example, pointed, e.g., in zigzag form as depicted in FIGS. 12(a) and (b), rounded, e.g., curved, sinusoidal or wave form as depicted in FIGS. 12(c) and (d), or flattened, e.g., trapezoidal as depicted in FIGS. 12(e) and (f). The shape of the ridges can also be different from the shape of the grooves, e.g., there can be a pointed ridge and a wave groove, a trapezoidal ridge and a pointed groove, and so forth.

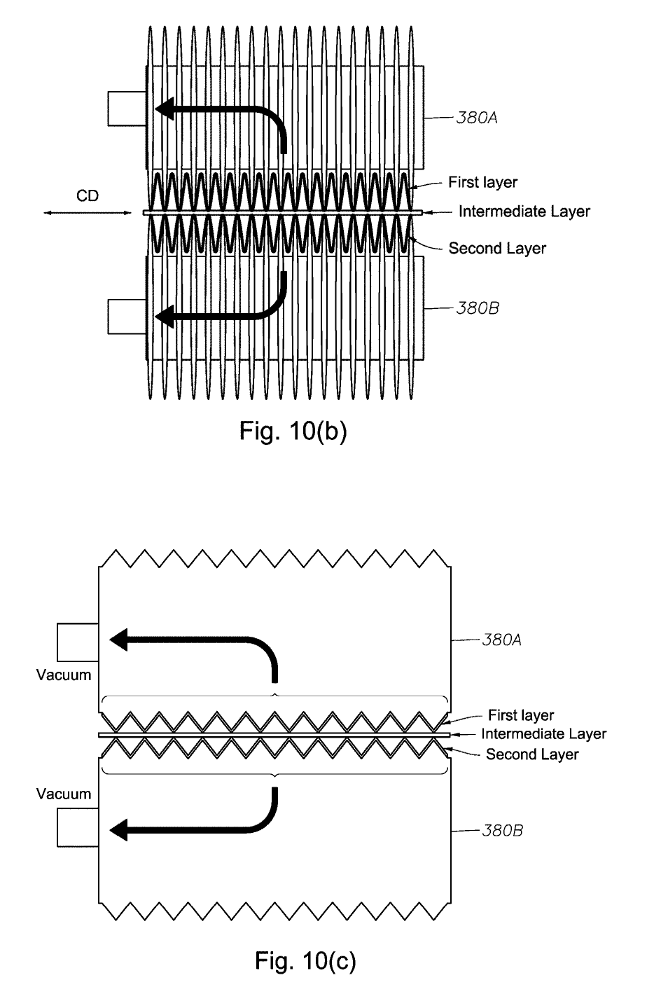

In some embodiments, as illustrated in FIG. 10(a), the ridged collecting surface is a rod having a series of vanes forming ridges. In other embodiments, as illustrated in FIG. 10(b), the ridged collecting surface is a series of parallel plates forming ridges. In some embodiments, as illustrated in FIG. 10(c), the ridged collecting surface is a corrugated surface on a set of counter-rotating vacuum drums.

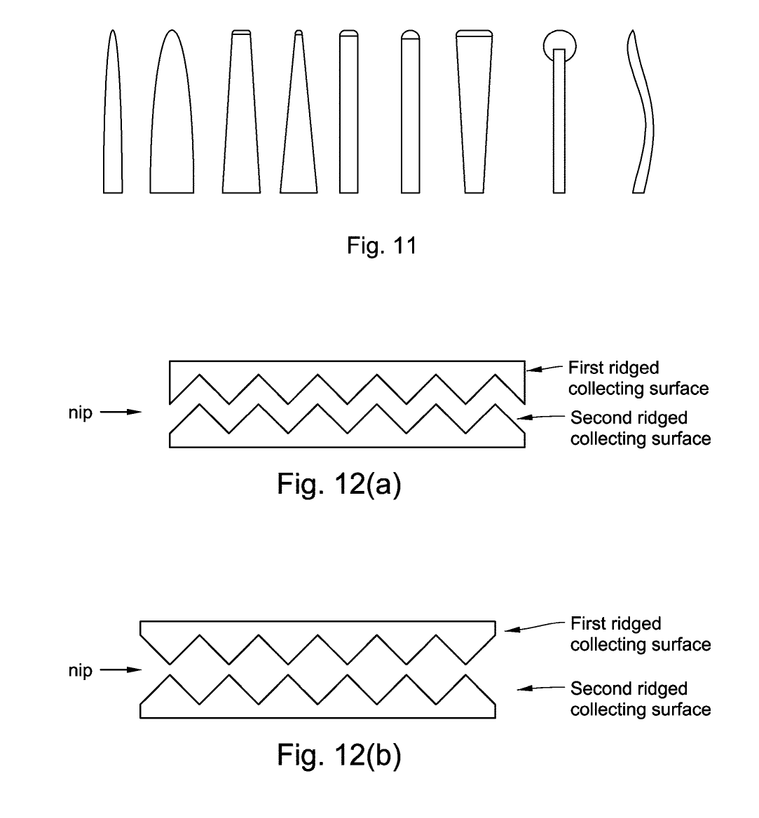

FIG. 11 depicts illustrative types of the shapes of ridges on the collecting surfaces, according to one or more embodiments described. The ridges can be solid or hollow. In some embodiments, the ridges have a flattened top to enhance bonding at contact points. Preferably, the ridges are slightly rounded instead of sharp at the edges to avoid stress points on the layer produced which may cause tears to the fabric when stretched or upon removal from the collecting surface.

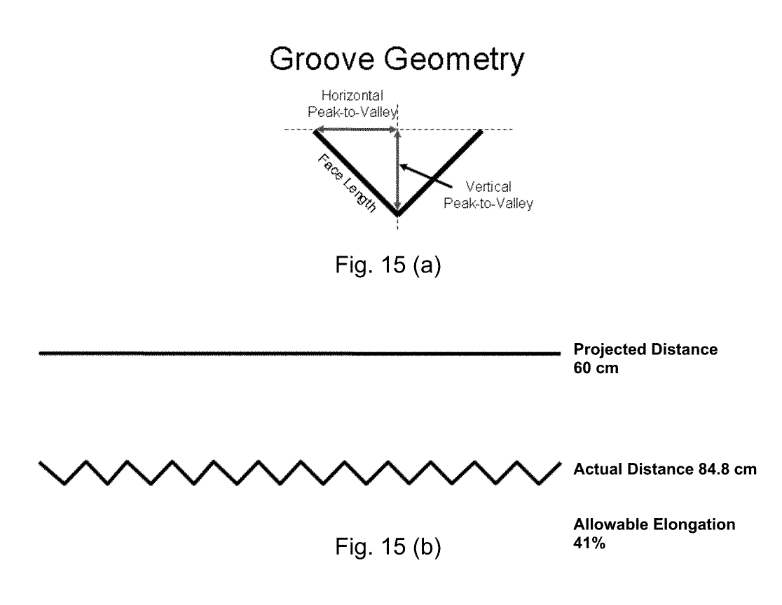

The ridged collecting surface increases the actual distance traveled by the layer as it moves across the collecting surface (“actual distance”) compared to the projected distance across the collecting surface (“projected distance”). FIG. 15(b) illustrates actual distance versus projected distance for a section of a zigzag shaped ridges where the straight line represents the projected distance and the zigzag line represents the actual distance. The actual distance is greater than the projected distance due to the series of peaks and valleys formed respectively by the ridges and grooves. The increase in actual distance relative to projected distance allows the ridged layer to be extended, i.e., the ridges can flatten out such that the layer is elongated from the projected distance up to the actual distance. The extension due to the ridges (distinguished from extension due to elasticity of the material forming the layer), without breaking or tearing the layer, can be expressed as percent allowable elongation:

Allowable elongation %=[(actual distance/projected distance)−1]×100.

In one embodiment, the ridged collecting surface provides an allowable elongation of at least about 20%, at least about 50%, at least about 100%, at least about 200%, or at least about 250%, preferably about 20% to about 300%, about 50% to about 250%, or about 100% to about 200%.

As used herein, “peak-to-valley horizontal distance” is one half of the distance between a peak and a peak, “peak-to-valley vertical distance” is the vertical distance between a peak and a valley, and “face length” is the actual distance covered by a layer traveling from a peak to a valley on the ridged surface. FIG. 15(a) identifies the peak-to-valley horizontal distance, peak-to-valley vertical distance, and face length in zigzag-shaped ridges. A “peak” is the highest point of a ridge, and a “valley” is the lowest point of a groove. In embodiments where the highest point of a ridge or the lowest point of a groove is not a point but a flat section, e.g., a trapezoidal or flattened shape, the midpoint of the highest flat section is considered the “peak,” and the midpoint of the lowest flat section is considered the “valley.”

A ridged collecting surface has an average peak-to-valley horizontal distance, which is the sum of the peak-to-valley horizontal distances for each peak divided by the total number of peaks; an average peak-to-valley vertical distance, which is the sum of the peak-to-valley vertical distances for each peak divided by the total number of peaks; and an average face length, which is one half the actual distance covered by the layer traveling across the ridged collecting surface divided by the total number of peaks.

Suitable peak-to-valley horizontal distances, peak-to-valley vertical distances, and face lengths depend on the type of multilayer layer desired and its intended use. In one embodiment, the ridged collecting surface has an average peak-to-valley vertical distance of at least about 1 mm, at least about 2 mm, at least about 3 mm, at least about 5 mm, or at least about 10 mm preferably, the average peak-to-valley vertical distance is about 1 mm to about 50 mm, about 1 mm to about 25 mm, or about 2 mm to about 25 mm, and more preferably about 2 mm to about 12 mm. In one embodiment, the ridged collecting surface has an average peak-to-valley horizontal distance of at least about 1 mm, at least about 2 mm, at least about 3 mm, at least about 5 mm, or at least about 10 mm preferably, the average peak-to-valley horizontal distance is about 1 mm to about 50 mm, about 1 mm to about 25 mm, or about 2 mm to about 25 mm, and more preferably about 2 mm to about 12 mm.

The ridged collecting surface is not limited to a fixed or repeating pattern and can have varying peak-to-valley horizontal and/or vertical distances. For example, the ridged collecting surface can have a fixed peak-to-valley horizontal distance and a fixed peak-to-valley vertical distance, a fixed peak-to-valley horizontal distance and varying peak-to-valley vertical distances, varying peak-to-valley horizontal distances and a fixed peak-to-valley vertical distance, or varying peak-to-valley horizontal and vertical distances.

The ridged collecting surface can comprise different sections having various ridge shapes, peak-to-valley horizontal distances, and/or peak-to-valley vertical distances. For example, the ridged collecting surface can have a first section in a zigzag shape having a fixed peak-to-valley horizontal distance and fixed peak-to-valley vertical distance, a second section in a wave shape having a fixed peak-to-valley horizontal distance and varying peak-to-valley vertical distances, and so forth. The invention encompasses all combinations of ridge shapes and peak-to-valley horizontal and vertical distances.

In one embodiment, the apparatus comprises two ridged collecting surfaces positioned opposite one another and creating a nip in between. This arrangement is illustrated in the pairs 380A and 380B, 480A and 480B, 580A and 580B, 680A and 680B, 780A and 780B, and 815A and 810B. The collecting surfaces can be both ridged and have the same or different ridges.

In one embodiment, the two ridged collecting surfaces have the same ridge shape and peak-to-valley horizontal and vertical distances, and are in the “male-female configuration,” i.e., the opposing collecting surfaces are identical except that where one collecting surface has a peak, the opposite collecting surface has a valley at the corresponding location, and vice-versa, such that the opposing peaks and valleys mesh with each other. In one embodiment, the peak is the inverted valley such that the opposing peaks and valleys mesh with essentially no gap in between. The two ridged collecting surfaces in the male-female configuration can have zigzag, sinusoidal, or trapezoidal shapes. FIG. 12(a) depicts zigzag-shaped ridges in the male-female configuration. FIG. 12(c) depicts sinusoidal ridges in the male-female configuration. FIG. 12(e) depicts trapezoidal ridges in the male-female configuration.

In a preferred embodiment, the two ridged collecting surfaces are in the “female-female configuration,” i.e., where one collecting surface has a peak, the opposite collecting surface also has a peak at the corresponding location, thereby creating a plurality of contact points for the opposing peaks. In one embodiment, the two ridged collecting surfaces are mirror images of each other, i.e., they have the same ridge shape and peak-to-valley horizontal and vertical distances. The two ridged collecting surfaces in the female-female configuration can have zigzag, sinusoidal, or trapezoidal shapes. FIG. 12(b) depicts zigzag-shaped ridges in the female-female configuration. FIG. 12(d) depicts sinusoidal ridges in the female-female configuration. In another embodiment, the ridged collecting surfaces have a trapezoidal shape, preferably arranged such that the flat surfaces of the trapezoids from one collecting surface correspond to the flat surfaces of the trapezoids from the opposing collecting surface. FIG. 12(f) depicts trapezoidal ridges in the female-female configuration.

In another embodiment, the two ridged collecting surfaces are out of phase with one another, i.e., the peaks and valleys of the opposing collecting surfaces neither mesh nor are in direct contact with each other.

The distances between the dies and the collecting surfaces can be adjusted depending on the desired multilayer composite to be produced. For example, reducing the DCD between a die and the collecting surface allows the layer produced therefrom to more closely conform to the ridges on the collecting surface. On the other hand, lengthening the DCD between the die and the collecting surface produces a layer that is less conforming to the ridges on the collecting surface. Typical die-to-collector distances can range from about 50 mm to 1 m or about 300 mm to 1 m.

The intermediate die produces an intermediate layer which passes through the nip created by the opposing collecting surfaces. A die-to-nip distance (“DND”) is the distance between the intermediate die and the narrowest point of the nip. A short DND allows the intermediate layer to conform to the ridges on at least one of the opposing collecting surfaces. Adjusting the distances between the intermediate die and first and/or second collecting surfaces affects the ridging on the intermediate layer produced. For example, reducing the distance between the intermediate die and the first collecting surface allows the intermediate layer to more closely conform to the ridges on the first collecting surface.

The “nip distance,” or the shortest distance in a gap between two collecting surfaces, can be adjusted depending on the desired multilayer composite to be produced. The nip distance should be the shortest distance while still maintaining the three-dimensional characteristics of the ridged multilayer composite to be produced. In some embodiments, the nip distance is about 80% to about 100% of the desired thickness of the multilayer composite to be produced.

### Method for Making a Multilayer Composite

In one embodiment, the invention encompasses a method for forming a multilayer composite by using any one of the apparatuses described herein.

In another embodiment, the invention encompasses a method for forming a multilayer composite comprising the steps of: (a) producing a first layer using a first die; (b) producing a second layer using a second die; (c) producing an intermediate layer using an intermediate die; (d) providing a first collecting surface positioned to collect the first layer and a second collecting surface positioned to collect the second layer, wherein the first and second collecting surfaces create a nip, and wherein at least one of the first and second collecting surfaces is ridged; (e) passing the first layer, the second layer, and the intermediate layer through the nip, wherein the intermediate layer is between the first layer and the second layer; and (f) forming a multilayer composite.

In one embodiment, the invention encompasses a method for forming a multilayer composite comprising the steps of: (a) producing a first layer using a first die; (b) producing a second layer using a second die; (c) providing a ridged first collecting surface positioned to collect the first layer and a ridged second collecting surface positioned to collect the second layer, wherein the first and ridged second collecting surfaces create a nip; (d) passing the first layer and the second layer through the nip; and (e) forming a multilayer composite.

In one embodiment, the invention encompasses a method for forming a multilayer composite comprising the steps of: (a) producing a first layer using a first die; (b) producing a second layer using a second die; (c) producing an intermediate layer using an intermediate die; (d) providing a ridged collecting surface positioned to collect the first layer, the second layer, and the intermediate layer to form a multilayer composite wherein the intermediate layer is between the first layer and the second layer; and (e) forming the multilayer composite.

In a preferred embodiment, the first and second collecting surfaces are both ridged. Preferably, at least one of the first and second collecting surfaces provides an allowable elongation of at least about 20% for at least one of the first layer and the second layer. Preferably, at least one of the first and second collecting surfaces has an average peak-to-valley vertical distance of at least about 2 mm, or about 2 mm to about 12 mm.

Preferably, at least one of the first and second layers has an average peak-to-valley vertical distance of at least about 2 mm, or about 2 mm to about 12 mm. In some embodiments, fibers from the meltblowing unit do not conform entirely to the ridged collecting surface, thus leaving gaps between the valleys of the layer and the ridged collecting surface. Examples of such embodiments are illustrated in FIGS. 10(a) and 10(b). In these instances, the peak-to-valley vertical distance for the layer will be less than that of the ridged collecting surface. The differences will vary depending on the operating parameters, the spacing, height and thickness of the ridges, and the material being meltblown. In some instances, the average peak-to-valley vertical distance for the collecting surface can be greater than that of the resulting layer by up to 10%, 20%, 50%, 100%, or 200% or more of the resulting layer. The portions of the fibers that are suspended over the ridges and not in contact with the collecting surface are typically fluffier and loftier in feel than those conforming to the collecting surface.

Preferably, at least one of the first layer, the second layer, and the intermediate layer is meltblown. Preferably, the intermediate layer is meltblown.

In a preferred embodiment, at least one of the first layer and the second layer comprises at least one of polypropylene and poly(ethylene terephthalate). Preferably, the first layer comprises at least one of polypropylene and poly(ethylene terephthalate), and the second layer comprises a polyalphaolefin having a pour point of −10° C. or less and a kinematic viscosity at 100° C. (KV100° C.) of 3 cSt or more.

In a preferred embodiment, the intermediate layer comprises an elastic resin. Preferably, the intermediate layer comprises a propylene-α-olefin copolymer comprising (i) at least about 50 wt % of the propylene-α-olefin copolymer, of propylene-derived units and (ii) about 5 wt % to about 35 wt % of the propylene-α-olefin copolymer, of units derived from at least one of ethylene and a C₄-C₁₀ α-olefin, wherein the polypropylene-α-olefin copolymer has a heat of fusion (H_{f}) of about 75 J/g or less, melting point of about 120° C. or less, and crystallinity of about 2 wt % to about 65 wt % of isotactic polypropylene.

The softness and spring-like property of the multilayer composite produced can be controlled by varying the stiffness of the material in the first and/or second layers (in addition to the ridging on the collecting surface). The stiffer the material used in the first and/or second layer, the more the multilayer composite will behave similar to a spring. In a preferred embodiment, the first layer comprises at least one of polypropylene and poly(ethylene terephthalate) (PET) in order to maintain the shape and structure of the multilayer composite, and the second layer, which may be the surface in contact with the body, comprises a poly-α-olefin (PAO) having a pour point of −10° C. or less and a kinematic viscosity at 100° C. (KV100° C.) of 3 cSt or more (e.g., SFT315 available from ExxonMobil Chemical Company, see, e.g., U.S. Pat. No. 7,795,366 and U.S. Pub. Nos. 2008/0070994, 2009/0041820) in order to provide more pleasing aesthetics or feel.

In a preferred embodiment, the material in the intermediate layer comprises an elastic resin. Preferably, the material in the intermediate layer comprises a propylene-α-olefin copolymer comprising: (i) at least about 50 wt % of the propylene-α-olefin copolymer, of propylene-derived units; and (ii) about 5 wt % to about 35 wt % of the propylene-α-olefin copolymer, of units derived from at least one of ethylene and a C₄-C₁₀ α-olefin, wherein the polypropylene-α-olefin copolymer has a H_{f} of about 75 J/g or less, melting point of about 120° C. or less, and crystallinity of about 2% to about 65% of isotactic polypropylene.

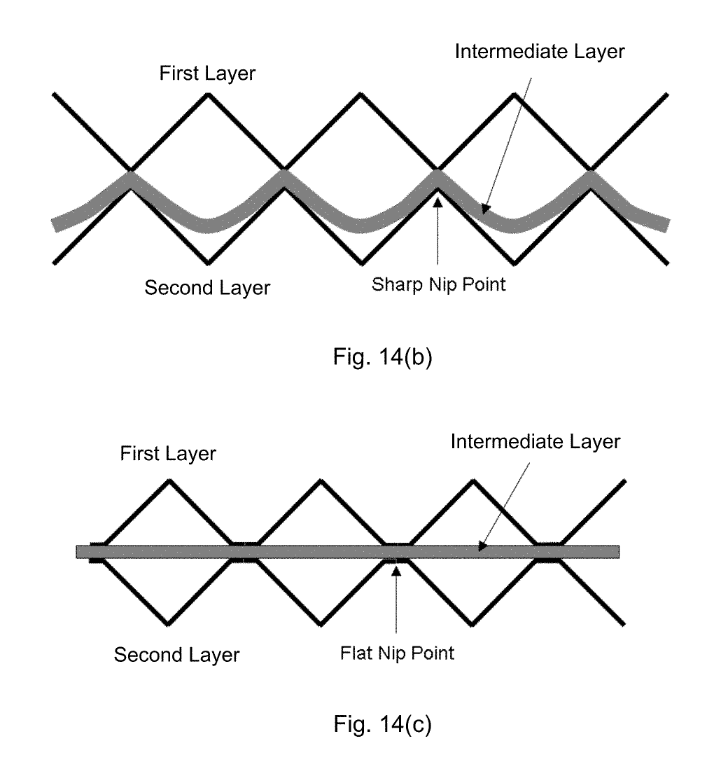

FIG. 14(a) illustrates a multilayer composite prepared from a method of the invention where the ridged first and second collecting surfaces are zigzag shaped and in the male-female configuration, and where the DCD between the first and second dies and their respective collecting surfaces and the DND are relatively short such that the first and second layers conform to the ridges of the respective collecting surfaces and such that the first layer, intermediate layer, and second layer are in essentially complete contact with each other. In some embodiments, the first and/or second layers comprise polypropylene or poly(ethylene terephthalate), and the intermediate layer comprises an elastic resin. In such embodiments, if, for example, the peak-to-valley vertical distance is 6.87 mm and the peak-to-valley horizontal distance is 3 mm, then the multilayer composite can be extended to 2.5 times its original length (150% allowable elongation), at which point it would stop due to the stiffer inelastic polypropylene layers no longer being able to extend. Upon release of the applied force, the elastic intermediate layer would contract and recoil the multilayer composite close to its original length and shape.

In a preferred embodiment, the ridged first and second collecting surfaces have ridges in the female-female configuration. FIG. 14(b) illustrates a multilayer composite prepared from a method of the invention where the ridged first and second collecting surfaces are zigzag shaped and in the female-female configuration, and where the DCD between the first and second dies and their respective collecting surfaces are relatively short such that the first and second layers conform to the ridges of the respective collecting surfaces, and the DND is relatively long such that the intermediate layer does not conform to the either the first or second collecting surface and such that the first layer, intermediate layer, and second layer are in incomplete contact with each other. In FIG. 14(b), the intermediate layer is in contact with the first and second layers at the contact points created by peaks from the ridged first and second surfaces and is in limited to no contact with the first and second layers over the valleys. In such embodiments, the actual distances of the first and second layers are greater than the actual distance of the intermediate layer. In some embodiments, the first and/or second layers comprise polypropylene or poly(ethylene terephthalate), and the intermediate layer comprises an elastic resin. As the multilayer composite is stretched, the ridges on the first and second layers flatten out so that the layers can be extended up to the allowable elongation, while the intermediate layer can be extended due to the elastic resin. Upon release of the applied load, the elastic intermediate layer would contract and recoil the multilayer composite to its original length and shape.

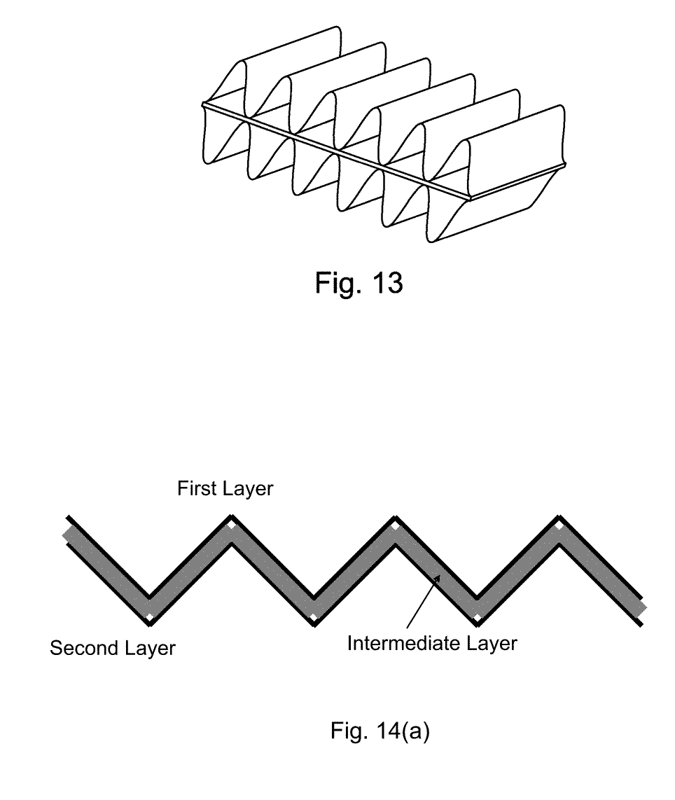

In some embodiments, the ridged first and second collecting surfaces have ridges in a flattened-tip (e.g., trapezoidal) shape and in the female-female configuration. FIG. 14(c) illustrates a multilayer composite prepared from a method of the invention where the ridged first and second collecting surfaces are in a flattened-tip shape and in the female-female configuration, and where the DCD between the first and second dies and their respective collecting surfaces are relatively short such that the layers conform to the ridges of the respective collecting surfaces, but the DND is relatively long such that the intermediate layer does not conform to the either the first or second collecting surface and is substantially flat. In FIG. 14(c), the intermediate layer is in contact with the first and second layers at the flattened contact surfaces created by the flattened peaks from the ridged first and second surfaces and is in limited to no contact with the first and second layers over the valleys. FIG. 13 provides a three-dimensional rendering of an illustrative multilayer composite where the ridged first and second collecting surfaces are sinusoidal shaped and in the female-female configuration. In such embodiments, the actual distances of the first and second layers are greater than the actual distance of the intermediate layer, and the flattened contact surface provides greater surface area for better bonding between the layers and suspension of the intermediate layer over the valleys. In some embodiments, the first and/or second layers comprise polypropylene or poly(ethylene terephthalate), and the intermediate layer comprises an elastic resin. The flattened contact surface can be adjusted in size and frequency to create dead zones in the multilayer composite to facilitate hook attachments as well as attachment of the composite across the chassis of a garment.

In one preferred embodiment, the intermediate layer is meltblown from a meltblowing unit that can operate at a melt pressure from greater than 500 psi (3.45 MPa) and a melt temperature within the range of 100° C. to 350° C.

In some embodiments, the first, second, and intermediate material may be meltblown into fibers generally within the range of from 0.5 to 250 μm in average diameter. In certain embodiments, the meltblown fibers can have a diameter within the range of from about 5 or 6 or 8 or 10 to about 20 or 50 or 80 or 100 or 150 or 200 or 250 μm in average diameter, and in other embodiments have a diameter from less than about 80 or 50 or 40 or 30 or 20 or 10 or 5 μm.

Preferably, the fibers formed from the first and/or second material have an average diameter of less than about 200 μm, less than 150 μm, less than 100 μm, less than 75 μm, less than 50 μm, less than 40 μm, less than 30 μm, less than 20 μm, less than 10 μm, less than 5 μm, less than 4 μm, less than 3 μm, less than 2 μm, or less than 1 μm, more preferably in the range of about 1 to 50 μm, 1 to 30 μm, 1 to 10 μm, or 1 to 5 μm, and more preferably about 2 to 5 μm.

Preferably, the fibers formed from the intermediate material have an average diameter of less than about 200 μm, less than 150 μm, less than 100 μm, less than 75 μm, less than 50 μm, less than 40 μm, or less than 30 μm, more preferably in the range of about 5 to 50 μm, 5 to 40 μm, 10 to 40 μm, 20 to 30 μm, and more preferably about 25 to 30 μm.

In some embodiments, the fiber diameters of each layer of the multilayer composite can be the same or different. Accordingly, a ratio of fiber diameters of adjacent layers can be the same or vary. For example, a ratio of fibers diameters of adjacent layers can range from a low of about 0.1:1 to a high of about 1:200. Such ratios can also range from about 1:150; 1:100; 1:75; 1:50; 1:25; 1:10; 1:5; or 1:2.

In some embodiments, at least 1% of the fibers in any given layer of the multilayer composite may be co-joined or married. More preferably, at least 2%, 5%, 10%, 15%, 20%, or 25% of the fibers in any given layer of the multilayer composite can be co-joined or married. The amount of co-joined or married fibers can also range from a low of about 1%, 5%, or 10% to a high of about 25%, 35%, or 45%.

In some embodiments, the fibers of any one or more layers of the multilayer composite can exhibit or possess some extent of fusion, melting, entrainment or mechanical interlocking with the fibers of any one or more adjoining layers without a sharp delineated interface between layers.

In some embodiments, the multilayer composite includes fabric having a basis weight within the range of from about 10 or 20 or 30 to 50 or 80 or 100 or 150 g/m². These fabrics may also be characterized by having an Ultimate Elongation from greater than 100%, 200%, 300%, 500%, or 1,000%. In this manner, multilayer composites can be formed having at least three meltblown layers (“MMM”). Other multilayer meltblown structures are contemplated such as MₓQ, QMₓQ, Mₓ, QMₓ, QₓS, MₓA_{y}M_{y}, QMₓA_{y}M_{y}Q, QMₓQM_{y}S, QMₓQM_{y}, MₓQM_{y}Q, QQMₓQ, where x is at least 3 and y is 0 to 100. For example, x can be 3 to 100; 3 to 50; 3 to 25; or 3 to 10; x can also range from a low of about 3, 4, or 5 to a high of about 6, 10, or 15; x can also range from a low of about 1, 2, 3, 4, or 5 to a high of about 6, 7, 8, 10, or 15. “M” represents a layer of meltblown fabric (where each “M” in a construction may be the same or different); “Q” represents a spunbond, spunlace, woven fabric, or film (where each “S” in a construction may be the same or different), and “A” represents one or more additives. Each of M, Q, and/or S may be ridged. When such adhering of the meltblown fibers to another fabric is desired, the secondary cooling air flow may be diminished and/or heated to maintain some of the melt quality and hence bonding ability of the forming elastic meltblown fibers to the fabrics upon which they are bonded.

In one embodiment, an intermediate material, such as an elastic resin, may be meltblown onto an additional fabric, such as extensible fabric (e.g., a spunlace fabric), that is passed underneath or in front of the forming meltblown layer. The melt temperature and distance between the spinnerets and the passing extensible fabric is adjusted such that the fibers are still in a melt or partial melt state when contacting the fabric(s) to form a multilayer composite. The coated fabric(s) then has the melted or partially-melted elastic meltblown fibers/fabric adhered thereto, and can be combined with one or more ridged meltblown layer(s) to form a multilayer composite.

The multilayer composite may be wound up into rolls for ease of handling and transportation. Preferably, where the first and second layers are the outermost layers, the first and/or second layer comprises a resin that will not cause the layer to readily stick to the other outer layer when compressed in a roll-up. For this reason, preferred resins in the first and/or second layers may include polypropylene, polyethylene, polyesters, and/or PAOs.

### Multilayer Composite

In one embodiment, the invention encompasses multilayer composites made using the apparatuses and/or methods disclosed herein. In one embodiment, the invention encompasses a multilayer composite comprising a first layer, a second layer, and an intermediate layer, wherein at least one of the first and second layers is ridged.

As used herein, a “composite” or “fabric” is a structure, preferably bendable and otherwise formable, having a thickness such that it impedes, but does not stop, the passage of air, the structure made from fibers that are bound together through chemical bonding, melt adhesion or entanglement (mechanical linkage) such that they form the structure. As used herein, a “fiber” is a material whose length is very much greater than its diameter or breadth: the average diameter is on the order of 1 to 250 μm, and includes natural and/or synthetic substances.

In another embodiment, the invention encompasses a multilayer composite comprising: (a) a ridged first layer having an allowable elongation of at least about 20%; (b) an intermediate layer comprising an elastic resin; and (c) a ridged second layer having an allowable elongation of at least about 20%, wherein the intermediate layer is between the ridged first layer and the ridged second layer.

In another embodiment, the invention encompasses a method for forming a multilayer composite comprising: (a) providing a ridged first layer having an allowable elongation of at least about 20%; (b) providing an intermediate layer comprising an elastic resin; (c) providing a ridged second layer having an allowable elongation of at least about 20%; and (d) contacting the intermediate layer with the ridged first layer and the ridged second layer to form a multilayer composite, wherein the intermediate layer is between the ridged first layer and the ridged second layer.

Preferably, at least one of the ridged first layer, ridged second layer, and the intermediate layer is meltblown. Preferably, the intermediate layer is meltblown.

In a preferred embodiment, at least one of the ridged first layer and the ridged second layer comprises at least one of polypropylene and PET. Preferably, the ridged first layer comprises at least one of polypropylene and poly(ethylene terephthalate), and the ridged second layer comprises a PAO having a pour point of −10° C. or less and a kinematic viscosity at 100° C. (KV100° C.) of 3 cSt or more.

Preferably, the elastic resin comprises a propylene-α-olefin copolymer comprising (i) at least about 50 wt % of the propylene-α-olefin copolymer, of propylene-derived units; and (ii) about 5 wt % to about 35 wt % of the propylene-α-olefin copolymer, of units derived from at least one of ethylene and a C₄-C₁₀ α-olefin, wherein the polypropylene-α-olefin copolymer has a H_{f} of about 75 J/g or less, melting point of about 120° C. or less, and crystallinity of about 2% to about 65% of isotactic polypropylene.

Preferably, at least one of the ridged first and second layers has an allowable elongation of at least about 50%, at least about 100%, at least about 200%, or at least about 250%, preferably about 20% to about 300%, about 50% to about 250%, or about 100% to about 200%.

Preferably, at least one of the ridged first layer and the ridged second layer has an average peak-to-valley vertical distance of at least about 2 mm, at least about 3 mm, at least about 5 mm, or at least about 10 mm. Preferably, the average peak-to-valley vertical distance is about 1 mm to about 50 mm, about 1 mm to about 25 mm, or about 2 mm to about 25 mm, and more preferably about 2 mm to about 12 mm.

In some embodiments, at least one layer of the multilayer composite, preferably the intermediate layer, can recover at least 50%, preferably at least 80%, of its original length after 100% extension and at least 50%, preferably at least 70%, of its original length after 200% extension. In one or more embodiments, the multilayer composite can recover at least 50%, preferably at least 80%, of its original length after 100% extension and at least 50%, preferably at least 70%, of its original length after 200% extension.

In some embodiments, the force at 50% extension of at least one layer of the multilayer composite, upon elongating the sample to 100% of its original length and then upon unloading, is about 1.3×10⁻³ lbf/in/gsm.

In some embodiments, the multilayer composite has a hydrohead of about 0.05 mbar/gsm or more. Preferably, the hydrohead is greater than about 0.1 mbar/gsm, 0.2 mbar/gsm, 0.3 mbar/gsm, 0.4 mbar/gsm, or 0.5 mbar/gsm. The hydrohead can also range from a low of about 0.1 mbar/gsm, 0.2 mbar/gsm or 0.3 mbar/gsm to a high of about 0.7 mbar/gsm, 0.8 mbar/gsm, or 0.9 mbar/gsm.

In some embodiments, the air permeability of any one or more layers of the multilayer composite is about 0.02 cm³/cm²/s or more. In one or more embodiments, the air permeability of the multilayer composite is about 0.02 cm³/cm²/s or more. The air permeability of any one or more layers of the multilayer composite or the multilayer composite itself can also range from a low of about 0.02 cm³/cm²/s, 0.05 cm³/cm²/s, or 1 cm³/cm²/s to a high of about 2 cm³/cm²/s, 3 cm³/cm²/s, 5 cm³/cm²/s, 10 cm³/cm²/s, 20 cm³/cm²/s, 50 cm³/cm²/s, or 100 cm³/cm²/s.

### Resins

The first layer, second layer, and intermediate layer can comprise one or more resins that are the same or different. Each resin can be an extensible resin, an elastic resin, or an inelastic resin. Suitable resins for any given layer can also comprise a blend of two or more resins, where each resin in extensible, inelastic, or elastic, such that the resulting blend can be extensible, inelastic, or elastic depending on the chosen resins, and their relatives amounts.

As used herein, materials, resins, fibers, and/or fabrics referred to as being “elastic” are those that can recover at least 70% after 100% deformation. As used herein, materials, resins, fibers, and/or fabrics referred to as being “inelastic” are those that can recover less than 20% after 100% deformation. As used herein, materials, resins, fibers, and/or fabrics referred to as being “extensible” are those that can recover 20% to 70% after 100% deformation, as determined by ASTM D412. Extensible materials and fabrics are well known in the art and are those formed, in one instance, from a material that is extensible or by mechanically distorting or twisting a fabric (natural or synthetic) such as described in U.S. Pat. No. 5,523,141.

Suitable resins for use in the multilayer composite can include cellulosics, nylons, polyacetals, polyalkylene naphthalates, polyesters, co-polyesters, polyurethane, polyamids, polyamides, polyolefins, polyolefin homopolymers, polyolefin copolymers, acrylic, and blends thereof. Except as stated otherwise, the term “copolymer” means a polymer derived from two or more monomers (including terpolymers, tetrapolymers, etc. that can be arranged in a random, block, or grafted distribution), and the term “polymer” refers to any carbon-containing compound having repeat units from one or more different monomers.

Preferred cellulosic materials include rayon and viscose. A preferred polyacetal is polyoxymethylene copolymer. Preferred polyesters include polyolefin-terephthalates and polyalkylene terephthalates, such as poly(ethylene terephthalate) (PET), poly(butylene terephthalate) (PBT), and poly(cyclohexane dimethylene terephthalate) (PCT).

Preferred polyolefins can be prepared from mono-olefin monomers including, but not limited to, monomers having 2 to 8 carbon atoms, such as ethylene, propylene, 1-butene, isobutylene, 1-pentene, 1-hexene, 1-octene, 3-methyl-1-pentene, 4-methyl-1-pentene, 5-methyl-1-hexene, mixtures thereof, and copolymers thereof with (meth)acrylates and/or vinyl acetates. Other suitable polyolefins can include one or more propylene homopolymers (100 wt % propylene-derived units), propylene copolymers, propylene-α-olefin copolymers, polypropylene impact copolymers (ICP), random copolymers (RCP) linear low density polyethylene, high density polyethylene, low density polyethylene, ethylene block copolymers (e.g., Infuse™ olefin block copolymers), styrenic block copolymers (e.g., Kraton™ styrenic copolymers), ethylene vinylacetates, urethanes, polyesters, and blends thereof. Certain specific extensible resins can include polyacrylonitrile, polybutylene terephthalate, polyethylene terephthalate (PET), polycyclohexylenedimethylene terephthalate (PCT), polyamide, and/or acrylic.

As used herein, “polypropylene” refers to a propylene homopolymer, or a copolymer of propylene, or some mixture of propylene homopolymers and copolymers. In certain embodiments, the polypropylene described herein is predominately crystalline, thus the polypropylene may have a melting point (Tₘ) greater than 110° C. or 115° C. or 130° C. The term “crystalline,” as used herein, characterizes those polymers which possess high degrees of inter- and intra-molecular order. In certain embodiments, the polypropylene has a H_{f} greater than 60 J/g or 70 J/g or 80 J/g, as determined by DSC analysis. The H_{f} is dependent on the composition of the polypropylene; the thermal energy for the highest order of polypropylene is estimated at 189 J/g that is, 100% crystallinity is equal to a H_{f} of 189 J/g. A polypropylene homopolymer will have a higher H_{f} than a copolymer or blend of homopolymer and copolymer.

In certain embodiments, the polypropylene(s) can be isotactic. Isotacticity of the propylene sequences in the polypropylenes can be achieved by polymerization with the choice of a desirable catalyst composition. The isotacticity of the polypropylenes as measured by ¹³C NMR, and expressed as a meso diad content is greater than 90% (meso diads [m]>0.90) or 95% or 97% or 98% in certain embodiments, determined as in U.S. Pat. No. 4,950,720 by ¹³C NMR. Expressed another way, the isotacticity of the polypropylenes as measured by ¹³C NMR, and expressed as a pentad content, is greater than 93% or 95% or 97% in certain embodiments.

The polypropylene can vary widely in composition. For example, substantially isotactic polypropylene homopolymer or propylene copolymer containing equal to or less than 10 wt % of other monomer, that is, at least 90 wt % propylene can be used. Further, the polypropylene can be present in the form of a graft or block copolymer, in which the blocks of polypropylene have substantially the same stereoregularity as the propylene-α-olefin copolymer (described below) so long as the graft or block copolymer has a sharp melting point above 110° C. or 115° C. or 130° C., characteristic of the stereoregular propylene sequences.

The polypropylene can be a combination of homopolypropylene, and/or random, and/or block copolymers as described herein. When the polypropylene is a random copolymer, the percentage of the α-olefin derived units in the copolymer is, in general, up to 5 wt % of the polypropylene, 0.5 wt % to 5 wt % in another embodiment, and 1 wt % to 4 wt % in yet another embodiment. The preferred comonomer derived from ethylene or α-olefins containing 4 to 12 carbon atoms. One, two or more comonomers can be copolymerized with propylene. Exemplary α-olefins may be selected from the group consisting of ethylene; 1-butene; 1-pentene-2-methyl-1-pentene-3-methyl-1-butene; 1-hexene-3-methyl-1-pentene-4-methyl-1-pentene-3,3-dimethyl-1-butene; 1-heptene; 1-hexene; 1-methyl-1-hexene; dimethyl-1-pentene; trimethyl-1-butene; ethyl-1-pentene; 1-octene; methyl-1-pentene; dimethyl-1-hexene; trimethyl-1-pentene; ethyl-1-hexene; 1-methylethyl-1-pentene; 1-diethyl-1-butene; propyl-1-pentene; 1-decene; methyl-1-nonene; 1-nonene; dimethyl-1-octene; trimethyl-1-heptene; ethyl-1-octene; methylethyl-1-butene; diethyl-1-hexene; 1-dodecene; and 1-hexadodecene.

The weight average molecular weight (Mw) of the polypropylene can be between about 50,000 g/mol to 3,000,000 g/mol, or from about 90,000 g/mol to 500,000 g/mol in another embodiment, with a molecular weight distribution (MWD, Mw/Mn) within the range from about 1.5 to 2.5; or 2.5 to 4.0; or 4.0 to 20.0. The polypropylene can have an MFR (2.16 kg/230° C.) up to about 500 dg/min, 1000 dg/min, 200 dg/min, or 3,000 dg/min, preferably in the range of from about 10 dg/min to 15 dg/min; or 15 dg/min to 30 dg/min; or 30 dg/min to 45 dg/min; or 40 dg/min to 50 dg/min.

The term “random polypropylene” (“RCP”) as used herein broadly means a single phase copolymer of propylene having up to 9 wt %, preferably 2 wt % to 8 wt % of an alpha olefin comonomer. Preferred alpha olefin comonomers have 2 carbon atoms, or from 4 to 12 carbon atoms. Preferably, the alpha olefin comonomer is ethylene.

The propylene impact copolymers (“ICP”) is heterogeneous and can include a first phase of from about 70 wt % to 95 wt % homopolypropylene and a second phase of from about 5 wt % to 30 wt % ethylene-propylene rubber, based on the total weight of the impact copolymer. The propylene impact copolymer can include 78 wt % to 95 wt % homopolypropylene and from 5 wt % to 22 wt % ethylene-propylene rubber, based on the total weight of the impact copolymer. In certain embodiments, the propylene-based polymer can include from about 90 wt % to 95 wt % homopolypropylene and from about 5 wt % to 10 wt % ethylene-propylene rubber, based on the total weight of the impact copolymer.

In one or more embodiments, the resin used in the multilayer composite comprises a thermoplastic rubber, synthetic polyisoprene (IR), butyl rubber (copolymer of isobutylene and isoprene, IIR), halogenated butyl rubbers (chloro-butyl rubber (CIIR); bromo-butyl rubber (BIIR)), polybutadiene (BR), styrene-butadiene rubber (SBR), SEBS block copolymers, SIS block copolymers, SBS block copolymers, ethylene-octene block copolymers, ethylene-octene copolymers, ethylene-hexene copolymers, ethylene-butene copolymers, nitrile rubber, hydrogenated nitrile rubbers, chloroprene rubber (CR), polychloroprene, neoprene, EPM (ethylene-propylene rubber) and EPDM rubbers (ethylene-propylene-diene rubber), epichlorohydrin rubber (ECO), polyacrylic rubber (ACM, ABR), silicone rubber, fluorosilicone rubber, fluoroelastomers, perfluoroelastomers, polyether block amides (PEBA), chlorosulfonated polyethylene (CSM), ethylene-vinyl acetate (EVA), thermoplastic elastomers (TPE), thermoplastic vulcanizates (TPV), thermoplastic polyurethane (TPU), thermoplastic olefins (TPO), polysulfide rubber, or blends of any two or more of these elastomers. In at least one specific embodiment, the elastic resin is or includes one or more polyolefin polymers. The term “polyolefin polymers” refers to homopolymers or copolymers of α-olefins having less than 40% crystallinity, or a H_{f} of less than 75 J/g.

In one or more preferred embodiments, at least one layer of the multilayer composite comprises at least one propylene-based or ethylene-based homopolymers or random, block, or graft copolymers comprising none (i.e., homopolymers) or from about 0.1 wt % or 1 wt % or 2 wt % or 5 wt % to 10 wt % or 15 wt % or 20 wt % or 45 wt % of the polymer, of comonomer-derived units selected from ethylene and C₄-C₁₀ α-olefins (propylene-based polymers) and C₃-C₁₀ α-olefins (ethylene-based polymers). Preferably, at least one layer of the multilayer composite includes one or more polypropylenes within the range of from about 50 wt % to 99 wt %; or 60 wt % to 95 wt %; or 50 wt % to 90 wt %; or 55 wt % to 85 wt %, by weight of the fabric layer/composition. In one or more embodiments, at least one layer of the multilayer composite consists essentially of one or more polypropylenes.

In certain embodiments, the resin used in the multilayer composite comprises one or more metallocene polyethylenes (“mPE's”), including one or more mPE homopolymers or copolymers. The mPE homopolymers or copolymers may be produced using mono- or bis-cyclopentadienyl transition metal catalysts in combination with an activator of alumoxane and/or a non-coordinating anion in solution, slurry, high pressure or gas phase. The catalyst and activator may be supported or unsupported and the cyclopentadienyl rings may be substituted or unsubstituted. Several commercial products produced with such catalyst/activator combinations are commercially available from ExxonMobil Chemical Company in Baytown, Tex. under the tradename EXACT™. For more information on the methods and catalysts/activators to produce such mPE homopolymers and copolymers see PCT Patent Application Publication Nos. WO 94/26816, WO 92/00333, WO 91/09882, WO 94/03506 and WO 94/03506; EP Nos. 0 277 003, 0 129 368, 0 520 732, 0 426 637, 0 573 403, 0 520 732, 0 495 375, 0 500 944, 0 570982 and 0 277004; U.S. Pat. Nos. 5,153,157, 5,198,401, 5,240,894, 5,324,800, 5,264,405, 5,096,867, 5,507,475, 5,055,438 and 5,017,714; and Canadian Patent No. 1,268,753.

In certain embodiments, the resin used in the multilayer composite comprises one or more termonomers and tetramonomers which may be one or more C₃-C₂₀ olefins, any C₄-C₂₀ linear, cyclic or branched dienes or trienes and any styrenic monomers such as styrene, alpha-methyl styrene, or para-methyl styrene. Preferred examples include butadiene, pentadiene, cyclopentadiene, hexadiene, cyclohexadiene, heptadiene, octadiene, nonadiene, norbornene, vinyl norbornene, ethylidene norbornene, isoprene, and heptadiene.

The C₃-C₂₀ and C₄-C₂₀ olefins can be any polymerizable olefin monomer and are preferably a linear, branched or cyclic olefin, even more preferably an alpha-olefin. Examples of suitable olefins include propylene, butene, isobutylene, pentene, isopentene, cyclopentene, hexene, isohexene, cyclohexene, heptene, isoheptene, cycloheptene, octene, isooctene, cyclooctene, nonene, cyclononene, decene, isodecene, dodecene, isodecene, 4-methyl-pentene-1, 3-methyl-pentene-1, and 3,5,5-trimethyl hexene-1. Suitable comonomers also include dienes, trienes, and styrenic monomers. Preferred examples include styrene, alpha-methyl styrene, para-alkyl styrene (such as para-methyl styrene), hexadiene, norbornene, vinyl norbornene, ethylidene norbornene, butadiene, isoprene, heptadiene, octadiene, and cyclopentadiene. Preferred comonomers for the copolymer of ethylene are propylene, butene, hexane, and/or octene.

### Preferred Intermediate Layer Resins

In a preferred embodiment, the intermediate layer of the multilayer composite comprises a propylene-alpha-olefin copolymer. Preferably, propylene-alpha-olefin comprises: (i) at least about 50 wt % of the propylene-α-olefin copolymer, of propylene-derived units; and (ii) about 5 wt % to about 35 wt % of the propylene-α-olefin copolymer, of units derived from at least one of ethylene and a C₄-C₁₀ α-olefin, wherein the polypropylene-α-olefin copolymer has a H_{f} of about 75 J/g or less, melting point of about 120° C. or less, and crystallinity of about 2% to about 65% of isotactic polypropylene.

In certain embodiments, the propylene-α-olefin copolymers have a density within the range from about 0.840 g/cm³ to 0.920 g/cm³, and from about 0.845 g/cm³ to 0.900 g/cm³ in another embodiment, and from about 0.850 g/cm³ to 0.890 g/cm³ in yet another embodiment, the values measured at room temperature per the ASTM D-1505 test method.

In certain embodiments, the propylene-α-olefin copolymers have a Shore A Hardness (ASTM D2240) within the range from about 10 or 20 to 80 or 90 Shore A. In yet another embodiment, the propylene-α-olefin copolymers possess an Ultimate Elongation (ASTM-D412) greater than 500%, 1,000% or 2,000%. The propylene-α-olefin copolymers can also have an Ultimate Elongation (ASTM-D412) ranging from a low of about 300%, 400%, or 500% to a high of about 800%, 1,200%, 1,800%, 2,000%, or 3,000%.

In certain embodiments, the propylene-α-olefin copolymers have a Mw value within the range from about 20,000 to 5,000,000 g/mole, and from about 50,000 to 1,000,000 g/mole in another embodiment, from about 70,000 to 400,000 g/mole in another embodiment, and from about 100,000 to 200,000 g/mole in another embodiment. In another embodiment, the propylene-α-olefin copolymers have a number average molecular weight (Mn) value within the range from about 4,500 to 2,500,000 g/mole, and from about 20,000 to 250,000 g/mole in yet another embodiment, and from about 50,000 to 200,000 g/mole in yet another embodiment. In yet another embodiment, the propylene-α-olefin copolymers have a z-average molecular weight (Mz) value within the range from about 20,000 to 7,000,000 g/mole, and from about 100,000 to 700,000 g/mole in another embodiment, and from about 140,000 to 500,000 g/mole in yet another embodiment.

In certain embodiments, a desirable molecular weight (and hence, a desirable MFR) is achieved by visbreaking the propylene-α-olefin copolymers. The “visbroken propylene-α-olefin copolymers” (also known in the art as “controlled rheology” or “CR”) is a copolymer that has been treated with a visbreaking agent such that the agent breaks apart the polymer chains. Non-limiting examples of visbreaking agents include peroxides, hydroxylamine esters, and other oxidizing and free-radical generating agents. Stated another way, the visbroken copolymer may be the reaction product of a visbreaking agent and the copolymer. In particular, a visbroken propylene-α-olefin copolymer is one that has been treated with a visbreaking agent such that its MFR is increased, in one embodiment by at least 10%, and at least 20% in another embodiment relative to the MFR value prior to treatment.

In certain embodiments, the MWD of the propylene-α-olefin copolymers is within the range from about 1.5 or 1.8 or 2.0 to 3.0 or 3.5 or 4.0 or 5.0 or 10.0. Techniques for determining the molecular weight (Mn, Mz and Mw) and MWD are as follows, and as by Verstate et al. in 21 MACROMOLECULES p. 3360 (1988). Conditions described herein govern over published test conditions. Molecular weight and molecular weight distribution are measured using a Waters 150 gel permeation chromatograph equipped with a Chromatix KMX-6 on-line light scattering photometer. The system was used at 135° C. with 1,2,4-trichlorobenzene as the mobile phase. Showdex™ (Showa-Denko America, Inc.) polystyrene gel columns 802, 803, 804 and 805 are used. This technique is discussed in LIQUID CHROMATOGRAPHY OF POLYMERS AND RELATED MATERIALS III 207 (J. Cazes ed., Marcel Dekker, 1981). No corrections for column spreading were employed; however, data on generally accepted standards, for example, National Bureau of Standards, Polyethylene (SRM 1484) and anionically produced hydrogenated polyisoprenes (an alternating ethylene-propylene copolymer) demonstrate that such corrections on Mw/Mn or Mz/Mw are less than 0.05 units. Mw/Mn was calculated from an elution time-molecular weight relationship whereas Mz/Mw was evaluated using the light scattering photometer. The numerical analyses can be performed using the commercially available computer software GPC2, MOLWT2 available from LDC/Milton Roy-Riviera Beach, Fla.

The propylene-α-olefin copolymers described herein can be produced using any catalyst and/or process known for producing polypropylenes. In certain embodiments, the propylene-α-olefin copolymers can include copolymers prepared according to the procedures in PCT Patent Application Publication No. WO 02/36651, U.S. Pat. No. 6,992,158, and/or PCT Patent Application Publication No. WO 00/01745. Preferred methods for producing the propylene-α-olefin copolymers are found in U.S. Patent Application Publication No. 2004/0236042 and U.S. Pat. No. 6,881,800. Preferred propylene-based polyolefin polymers are available commercially under the trade names VISTAMAXX™ (ExxonMobil Chemical Company, Houston, Tex., USA) and VERSIFY™ (The Dow Chemical Company, Midland, Mich., USA), certain grades of TAFMER™ XM or NOTIO™ (Mitsui Company, Japan), certain grades of LMPO™ from Idemitsu, or certain grades of SOFTELL™ (Lyondell Basell Polyolefine GmbH, Germany). A commercial example of an ethylene-based polyolefin block copolymer is INFUSE™ olefin block copolymers from Dow Chemical.

In one or more embodiments, the intermediate layer includes at least one propylene-α-olefin copolymer resin and at least one polypropylene resin, either as reactor grade or a blend. For example, a preferred blend includes 50 wt % of one or more propylene-α-olefin copolymer resins and 50 wt % of one or more polypropylene resins. The amount of the propylene-α-olefin copolymer resin in the blend can range from a low of about 20 wt %, 30 wt %, or 40 wt % to a high of about 60 wt %, 70 wt %, 90 wt %, 95 wt %, or 99 wt %. The amount of the polypropylene resin in the blend can range from a low of about 1 wt %, 5 wt %, or 10 wt % to a high of about 20 wt %, 30 wt %, or 45 wt %.

The MFR (ASTM D1238, 230° C., 2.16 kg) of resin or blend in the intermediate layer is preferably less than 2,000 dg/min (g/10 min), more preferably 1,500 dg/min or less, 1,200 dg/min or less, 900 dg/min or less, 600 dg/min or less, 300 dg/min or less, 200 dg/min or less, 150 dg/min or less, 100 dg/min or less, or 90 dg/min or less. In certain embodiments, the MFR of the resin or blend can range from a low of about 3 dg/min or less, 10 dg/min, 20 dg/min, 50 dg/min, 75 dg/min, or 80 dg/min to a high of about 250 dg/min, 500 dg/min, 1,000 dg/min, or 3000 dg/min. The MFR of the resin or blend can also range from a low of about 20 dg/min, 30 dg/min, or 40 dg/min to a high of about 90 dg/min, 120 dg/min, or 150 dg/min. The MFR of the resin or blend can also range from a low of about 25 dg/min, 35 dg/min, or 45 dg/min to a high of about 75 dg/min, 85 dg/min, or 95 dg/min. The MFR of the resin or blend can further range from a low of about 0.1 dg/min, 0.5 dg/min, 1 dg/min, or 5 dg/min to a high of about 30 dg/min, 40 dg/min, 70 dg/min, or 90 dg/min. In at least one specific embodiment, the MFR of the resin or blend ranges from about 2 dg/min to about 90 dg/min; about 2 dg/min to about 20 dg/min; about 3 dg/min to about 90 dg/min; or about 3 dg/min to about 20 dg/min.

The Mw of resin or blend in the intermediate layer is preferably less than 500,000; 400,000; 300,000; or 250,000. For example, the Mw of the resin or blend can range from about 50,000 to about 290,000. In one or more embodiments, the Mw of the resin or blend can range from a low of about 50,000, 65,000, or 80,000 to a high of about 130,000, 190,000, or 290,000. In one or more embodiments, the Mw of the resin or blend can range from about 80,000 to about 285,000; 80,000 to about 240,000; or 80,000 to about 140,000.

Preferred First and/or Second Layer Resins

In a preferred embodiment, at least one of the first and second layers comprises at least one of polypropylene and PET.

In one or more preferred embodiments, at least one of the first and second layers comprises a blend of polypropylene and less than 50 wt % of one or more blend components. The blend component can be one or more impact copolymers, one or more random copolymers (RCP), one or more polyethylenes, one or more polyethylenes having a Mw of less than 20,000 g/mol, one or more polypropylenes having a Mw of less than 20,000 g/mol, one or more PAOs, or any combination(s) thereof. The amount of the blend component (not the polypropylene) can be present in an amount ranging from a low of about 0.5 wt %, 1 wt %, or 5 wt % to a high of about 30 wt %, 40 wt %, or 50 wt %. For example, the amount of the blend component can be of from about 1 wt % to 49 wt %; or about 5 wt % to 45 wt %; or about 5 wt % to 40 wt %; or about 5 wt % to 25 wt %.

In a preferred embodiment, at least one of the first and second layers comprises a PAO. Preferably, one of the first and second layers comprises at least one of polypropylene andPET, and the other layer comprises a PAO.

PAOs are high purity hydrocarbons, with a fully paraffinic structure and a high degree of branching. Suitable PAOs are liquids with a pour point of −10° C. or less and a kinematic viscosity at 100° C. (KV100° C.) of 3 cSt or more. Such PAOs can include C₁₅ to C₁₅₀₀ (preferably C₂₀ to C₁₀₀₀, preferably C₃₀ to C₈₀₀, preferably C₃₅ to C₄₀₀, most preferably C₄₀ to C₂₅₀) oligomers (such as dimers, trimers, etc) of C₃ to C₂₄ (preferably C₅ to C₁₈, preferably C₆-C₁₄, preferably C₈-C₁₂) α-olefins, preferably linear α-olefins (LAOs), provided that C₃ and C₄ α-olefins are present at 30 wt % or less (preferably 20 wt % or less, preferably 10 wt % or less, preferably 5 wt % or less). Suitable LAOs include: propylene; 1-butene; 1-pentene; 1-hexene; 1-heptene; 1-octene; 1-nonene; 1-dec ene; 1-undecene; 1-dodecene; 1-tridecene; 1-tetradecene; 1-pentadecene; 1-hexadecene; and blends thereof.

In one or more embodiments, a single LAO is used to prepare the oligomers. A preferred embodiment involves the oligomerization of 1-octene or 1-decene, preferably 1-decene. In one or more embodiments, the PAO is or includes oligomers of two or more C₃-C₁₈ LAOs, to make ‘bipolymer’ or ‘terpolymer’ or higher-order copolymer combinations, provided that C₃ and C₄ LAOs are present 30 wt % or less (preferably 20 wt % or less, preferably 10 wt % or less, preferably 5 wt % or less). A preferred embodiment involves oligomerization of a mixture of LAOs selected from C₆-Cis LAOs with even carbon numbers. Another preferred embodiment involves oligomerization of 1-octene, 1-decene, and 1-dodecene.

In one or more embodiments, the PAO comprises oligomers of a single α-olefin species having a carbon number of 5 to 24 (preferably 6 to 18, more preferably 8 to 12, most preferably 10). In one or more embodiments, the PAO comprises oligomers of mixed α-olefins (i.e., two or more α-olefin species), each α-olefin having a carbon number of 5 to 24 (preferably 6 to 18, preferably 8 to 12). In one or more embodiments, the PAO comprises oligomers of mixed α-olefins (i.e., involving two or more α-olefin species) where the weighted average carbon number for the α-olefin mixture is 6 to 14 (preferably 8 to 12, preferably 9 to 11).

In one or more embodiments, the PAO or blend of PAOs has a Mₙ of from about 400 to 15,000 g/mol (preferably 400 to 12,000 g/mol, preferably about 500 to 10,000 g/mol, preferably about 600 to 8,000 g/mol, preferably about 800 to 6,000 g/mol, preferably about 1,000 to 5,000 g/mol). In one or more embodiments, the PAO or blend of PAOs has a Mₙ greater than 1,000 g/mol (preferably greater than 1,500 g/mol, preferably greater than 2,000 g/mol, preferably greater than 2,500 g/mol).

In one or more embodiments, the PAO or blend of PAOs has a KV100° C. of 3 cSt or more (preferably 4 cSt or more, preferably 5 cSt or more, preferably 6 cSt or more, preferably 8 cSt or more, preferably 10 cSt or more, preferably 20 cSt or more, preferably 30 cSt or more, preferably 40 cSt or more, preferably 100 or more, preferably 150 cSt or more). In one or more embodiments, the PAO has a KV100° C. of 3 to 3,000 cSt (preferably 4 to 1,000 cSt, preferably 6 to 300 cSt, preferably 8 to 150 cSt, preferably 8 to 100 cSt, preferably 8 to 40 cSt). In one or more embodiments, the PAO or blend of PAOs has a KV100° C. of 10 to 1000 cSt (preferably 10 to 300 cSt, preferably 10 to 100 cSt). In yet another embodiment, the PAO or blend of PAOs has a KV100° C. of 4 to 8 cSt. In yet another embodiment, the PAO or blend of PAOs has a KV100° C. of 25 to 300 cSt (preferably 40 to 300 cSt, preferably 40 to 150 cSt). In one or more embodiments, the PAO or blend of PAOs has a KV100° C. of 100 to 300 cSt.

In one or more embodiments, the PAO or blend of PAOs has a Viscosity Index (VI) of 120 or more (preferably 130 or more, preferably 140 or more, preferably 150 or more, preferably 170 or more, preferably 190 or more, preferably 200 or more, preferably 250 or more, preferably 300 or more). In one or more embodiments, the PAO or blend of PAOs has a VI of 120 to 350 (preferably 130 to 250).

In one or more embodiments, the PAO or blend of PAOs has a pour point of −10° C. or less (preferably −20° C. or less, preferably −25° C. or less, preferably −30° C. or less, preferably −35° C. or less, preferably −40° C. or less, preferably −50° C. or less). In one or more embodiments, the PAO or blend of PAOs has a pour point of −15 to −70° C. (preferably −25 to −60° C.).

In one or more embodiments, the PAO or blend of PAOs has a glass transition temperature (T_{g}) of −40° C. or less (preferably −50° C. or less, preferably −60° C. or less, preferably −70° C. or less, preferably −80° C. or less). In one or more embodiments, the PAO or blend of PAOs has a T_{g} of −50 to −120° C. (preferably −60 to −100° C., preferably −70 to −90° C.).

In one or more embodiments, the PAO or blend of PAOs has a flash point of 200° C. or more (preferably 210° C. or more, preferably 220° C. or more, preferably 230° C. or more), preferably between 240° C. and 290° C. In one or more embodiments, the PAO or blend of PAOs has a specific gravity (15.6° C.) of 0.86 or less (preferably 0.855 or less, preferably 0.85 or less, preferably 0.84 or less).

In one or more embodiments, the PAO or blend of PAOs has a molecular weight distribution (M_{w}/Mₙ) of 2 or more (preferably 2.5 or more, preferably 3 or more, preferably 4 or more, preferably 5 or more, preferably 6 or more, preferably 8 or more, preferably 10 or more). In one or more embodiments, the PAO or blend of PAOs has a M_{w}/Mₙ of 5 or less (preferably 4 or less, preferably 3 or less) and a KV100° C. of 10 cSt or more (preferably 20 cSt or more, preferably 40 cSt or more, preferably 60 cSt or more).

Desirable PAOs are commercially available as SpectraSyn™ and SpectraSyn Ultra™ from ExxonMobil Chemical (USA). Other useful PAOs include those available as Synfluid™ from ChevronPhillips Chemical (USA), as Durasyn™ from Innovene (USA), as Nexbase™ from Neste Oil (Finland), and as Synton™ from Chemtura (USA). For PAOs, the percentage of carbons in chain-type paraffinic structures (CP) is close to 100% (typically greater than 98% or even 99%). Additional details are described in, for example, U.S. Pat. Nos. 3,149,178; 4,827,064; 4,827,073; 5,171,908; and 5,783,531, and in Synthetic Lubricants and High-Performance Functional Fluids (Leslie R. Rudnick & Ronald L. Shubkin, ed. Marcel Dekker, Inc. 1999), pp. 3-52.

The MFR (ASTM D1238, 230° C., 2.16 kg) of the resin or blend in the first and/or second layer is preferably less than 3,000 dg/min, 2,000 dg/min (g/10 min), more preferably 1,500 dg/min or less, 1,200 dg/min or less, 900 dg/min or less, 600 dg/min or less, 300 dg/min or less, 200 dg/min or less, 150 dg/min or less, 100 dg/min or less, or 90 dg/min or less. In certain embodiments, the MFR of the resin or blend can range from a low of about 50 dg/min, 75 dg/min, or 80 dg/min to a high of about 250 dg/min, 500 dg/min, or 1,000 dg/min. The MFR of the resin or blend can also range from a low of about 10 dg/min, 20 dg/min, 30 dg/min, or 40 dg/min to a high of about 90 dg/min, 120 dg/min, or 150 dg/min. The MFR of the resin or blend can also range from a low of about 10 dg/min, 20 dg/min, 35 dg/min, or 45 dg/min to a high of about 65 dg/min, 80 dg/min, 95 dg/min, 150 dg/min, up to 3,000 dg/min. The MFR of the layer resin or blend can further range from a low of about 0.1 dg/min, 0.5 dg/min, 1 dg/min, or 5 dg/min to a high of about 30 dg/min, 40 dg/min, 70 dg/min, or 90 dg/min.

The Mw of the resin or blend in the first and/or second layer is preferably less than about 500,000; 400,000; 300,000; or 250,000. For example, the Mw of the resin or blend can range from about 30,000 to 500,000, or about 50,000 to 200,000. In one or more embodiments, the Mw of the resin or blend can range from a low of about 50,000, 80,000, or 100,000 to a high of about 155,000, 170,000, or 190,000. In one or more embodiments, the Mw of the resin or blend can range from about 80,000 to 200,000; about 100,000 to 175,000; or about 140,000 to 180,000.

### Additives

Any of the resins or layers can further include one or more additives. Suitable additives can include any one or more processing oils (aromatic, paraffinic and napthathenic mineral oils), compatibilizers, calcined clay, kaolin clay, nanoclay, talc, silicates, carbonates, sulfates, carbon black, sand, glass beads, mineral aggregates, wollastonite, mica, glass fiber, other filler, pigments, colorants, dyes, carbon black, filler, dispersants, flame retardants, antioxidants, conductive particles, UV-inhibitors, stabilizers, light stabilizer, light absorber, coupling agents including silanes and titanates, plasticizers, lubricants, blocking agents, antiblocking agents, antistatic agents, waxes, foaming agents, nucleating agents, slip agents, acid scavengers, lubricants, adjuvants, surfactants, crystallization aids, polymeric additives, defoamers, preservatives, thickeners, rheology modifiers, humectants, coagents, vulcanizing/cross-linking/curative agents, vulcanizing/cross-linking/curative accelerators, cure retarders, and combinations thereof.

In certain embodiments, adhesives are preferably substantially absent from the constructions, meaning that adhesives are not used to secure the layers of fabric and/or film to one another. As used herein, an “adhesive” is a substance that is used to secure two layers of film or fabric to one another as is known in the art. Examples of adhesive substances include: polyolefins; polyvinyl acetate polyamides; hydrocarbon resins; waxes; natural asphalts; styrenic rubbers; and blends thereof. Also, in each configuration 300, 400, 500, 600, 700, and 800 described, the innermost layer, or intermediate layer, can be blown symmetrically with respect to the nip of the collecting surface(s), as depicted in FIGS. 3-8, and although not shown, the intermediate layer in each configuration 300, 400, 500, 600, 700, and 800 described can be blown asymmetrically with respect to the nip of the collecting surface(s).

### Articles

The multilayer composites made from the apparatuses and methods of the invention are particularly useful for applications requiring any one or more of the following properties or attributes: elasticity, absorbency, liquid repellency, resilience, stretch, softness, strength, flame retardancy, washability, cushioning, filtering, bacterial barrier, and sterility. Illustrative applications and uses can include, but are not limited to, hygiene, medical, filters, and geotextiles, among others.

For example, the multilayer composites can be used to make baby diapers, feminine hygiene napkins, adult incontinence products, personal hygiene wipes, bandages, wound dressings, air filters, liquid filters, household wipes, shop towels, battery separators, vacuum cleaner bags, cosmetic pads, food packaging, clothing, apparels, medical garments, and disposable underwear. Particularly suitable uses include closure systems on baby diapers, pull-ups, training pants, adult incontinence briefs and diapers, bandages, and other single use or disposable items, and also as liquid transport layers in such items.

Common filtering uses include gasoline, oil and air filters; water, coffee and tea bags; liquid cartridge and bag filters; vacuum bags; and allergen membranes. Illustrative geotextiles and uses thereof include soil stabilizers and roadway underlayment, foundation stabilizers, erosion control, canals construction, drainage systems, geomembranes protection, frost protection, agriculture mulch, pond and canal water barriers, and sand infiltration barrier for drainage tile.

Additional articles and uses of the multilayer composites provided herein can include, for example, carpet backing, marine sail laminates, table cover laminates, chopped strand mat, backing/stabilizer for machine embroidery, packaging, insulation, pillows, cushions, and upholstery padding, batting in quilts or comforters, consumer and mailing envelopes, tarps, as well as tenting and transportation (lumber, steel) wrapping.

The entire article can be formed from the multiplayer composites, or the multilayer composites can form individual sections or portions thereof. For example, in baby diapers, it is envisaged that the multilayer constructions form at least part of the back sheet, wings, and/or tabs.

### Examples

Table 1 illustrates how allowable elongation can be increased by increasing the peak-to-valley vertical distance. For example, where the peak-to-valley horizontal distance, or projected distance, is 3 mm and the peak-to-valley vertical distance is 5 2 mm, the face length, or actual distance, is 6.0 mm, which is double the projected distance, thereby providing 100% allowable elongation.

TABLE 1
Effect of Increasing Peak-to-Valley Vertical
Distance on Allowable Elongation

| Peak-to-Valley | | Face | Face Length/ | |
|---|---|---|---|---|
| Horizontal | Peak-to- | Length | Peak-to-Valley | |
| (Projected | Valley | (Actual | Horizontal Ratio | Allowable |
| Distance) | Vertical | Distance) | (Actual Distance/ | Elongation |
| (mm) | (mm) | (mm) | Projected Distance) | (%) |
| 3 | 0 | 3 | 1.00 | 0% |
| 3 | 2 | 3.6 | 1.20 | 20% |
| 3 | 3 | 4.2 | 1.41 | 41% |
| 3 | 3.35 | 4.5 | 1.50 | 50% |
| 3 | 4 | 5.0 | 1.67 | 67% |
| 3 | 5 | 5.8 | 1.94 | 94% |
| 3 | 5.20 | 6.0 | 2.00 | 100% |
| 3 | 6 | 6.7 | 2.24 | 124% |
| 3 | 6.87 | 7.5 | 2.50 | 150% |
| 3 | 7 | 7.6 | 2.54 | 154% |
| 3 | 8 | 8.5 | 2.85 | 185% |
| 3 | 8.49 | 9.0 | 3.00 | 200% |
| 3 | 9 | 9.5 | 3.16 | 216% |
| 3 | 10 | 10.4 | 3.48 | 248% |
| 3 | 10.06 | 10.5 | 3.50 | 250% |

Embodiments of the invention include:

1. An apparatus for making a multilayer composite, comprising:

a first extruder;

a first die connected to the first extruder for producing a first layer;

a second extruder;

a second die connected to the second extruder for producing a second layer;

an intermediate extruder;

an intermediate die connected to the intermediate extruder for producing an intermediate layer and positioned such that the intermediate layer is between the first and second layers;

a first collecting surface positioned to collect the first layer; and

a second collecting surface positioned to collect the second layer,

wherein the first and second collecting surfaces create a nip through which the first layer, the second layer, and the intermediate layer are passed to form a multilayer composite, and

wherein at least one of the first and second collecting surfaces is ridged.

2. The apparatus of paragraph 1, wherein the first and second collecting surfaces are ridged.
3. The apparatus of paragraph 2, wherein at least one of the first and second collecting surfaces has an average peak-to-valley vertical distance of at least about 2 mm.
4. The apparatus of paragraph 2, wherein at least one of the first and second collecting surfaces has an average peak-to-valley vertical distance of about 2 mm to about 12 mm.
5. The apparatus of paragraph 2, wherein the first and second collecting surfaces are out of phase with one another or in the female-female configuration.
6. The apparatus of paragraph 2, wherein at least one of the first and second collecting surfaces have ridges in a flattened-tip shape.
7. The apparatus of paragraph 1, further comprising a third extruder and a third die for producing a third layer, wherein the third die is connected to the third extruder and positioned such that the first layer, the second layer, the third layer, and the intermediate layer pass through the nip to form a multilayer composite.
8. The apparatus of paragraph 7, further comprising a fourth extruder and a fourth die for producing a fourth layer, wherein the fourth die is connected to the fourth extruder and positioned such that the first layer, the second layer, the third layer, the fourth layer, and the intermediate layer pass through the nip to form a multilayer composite.
9. The apparatus of paragraph 1, wherein the first and second collecting surfaces are counter-rotating drums.
10. The apparatus of paragraph 1, wherein at least one of the first and second collecting surfaces is a series of parallel plates forming ridges.
11. The apparatus of paragraph 1, wherein at least one of the first and second collecting surfaces is a rod having a series of vanes forming ridges.
12. A multilayer composite made by the apparatus of paragraph 1.
13. An apparatus for making a multilayer composite, comprising:

a first extruder;

a first die connected to the first extruder for producing a first layer;

a second extruder;

a second die connected to the second extruder for producing a second layer;

a ridged first collecting surface positioned to collect the first layer; and

a ridged second collecting surface positioned to collect the second layer,

wherein the first and second ridged collecting surfaces create a nip through which the first layer and the second layer are passed to form a multilayer composite.

14. The apparatus of paragraph 13, wherein at least one of the first and ridged second collecting surfaces has an average peak-to-valley vertical distance of at least about 2 mm.
15. The apparatus of paragraph 13, wherein at least one of the first and ridged second collecting surfaces has an average peak-to-valley vertical distance of about 2 mm to about 12 mm.
16. An apparatus for making a multilayer composite, comprising:

a first extruder;

a first die connected to the first extruder for producing a first layer;

a second extruder;

a second die connected to the second extruder for producing a second layer;

an intermediate extruder;

an intermediate die connected to the intermediate extruder for producing an intermediate layer and positioned such that the intermediate layer is between the first and second layers; and

a ridged collecting surface positioned to collect the first layer, the second layer, and the intermediate layer to form a multilayer composite.

17. The apparatus of paragraph 16, wherein the ridged collecting surface has an average peak-to-valley vertical distance of at least about 2 mm.
18. The apparatus of paragraph 16, wherein the ridged collecting surface has an average peak-to-valley vertical distance of about 2 mm to about 12 mm.
19. A method for forming a multilayer composite comprising the steps of:

(a) producing a first layer using a first die;

(b) producing a second layer using a second die;

(c) producing an intermediate layer using an intermediate die;

(d) providing a first collecting surface positioned to collect the first layer and a second collecting surface positioned to collect the second layer, wherein the first and second collecting surfaces create a nip, and wherein at least one of the first and second collecting surfaces is ridged;

(e) passing the first layer, the second layer, and the intermediate layer through the nip, wherein the intermediate layer is between the first layer and the second layer; and

(f) forming a multilayer composite.

20. The method of paragraph 19, wherein the first and second collecting surfaces are ridged.
21. The method of paragraph 20, wherein at least one of the first and second collecting surfaces provides an allowable elongation of at least about 20% for at least one of the first layer and the second layer.
22. The method of paragraph 20, wherein at least one of the first and second collecting surfaces has an average peak-to-valley vertical distance of at least about 2 mm.
23. The method of paragraph 20, wherein at least one of the first and second collecting surfaces has an average peak-to-valley vertical distance of about 2 mm to about 12 mm.
24. The method of paragraph 19, wherein at least one of the first and second layers has an average peak-to-valley vertical distance of at least about 2 mm.
25. The method of paragraph 19, wherein at least one of the first and second layers has an average peak-to-valley vertical distance of about 2 mm to about 12 mm.
26. The method of paragraph 19, wherein at least one of the first layer, the second layer, and the intermediate layer is meltblown.
27. The method of paragraph 19, wherein the intermediate layer is meltblown.
28. The method of paragraph 19, wherein at least one of the first layer and the second layer comprises at least one of polypropylene and poly(ethylene terephthalate).
29. The method of paragraph 19, wherein the first layer comprises at least one of polypropylene and poly(ethylene terephthalate), and the second layer comprises a polyalphaolefin having a pour point of −10° C. or less and a kinematic viscosity at 100° C. (KV100° C.) of 3 cSt or more.
30. The method of paragraph 19, wherein the intermediate layer comprises an elastic resin.
31. The method of paragraph 19, wherein the intermediate layer comprises a propylene-alpha-olefin copolymer comprising:
a. at least about 50 wt % of the propylene-alpha-olefin copolymer, of propylene-derived units; and
b. about 5 wt % to about 35 wt % of the propylene-alpha-olefin copolymer, of units derived from at least one of ethylene and a C₄-C₁₀ alpha-olefin, wherein the polypropylene-alpha-olefin copolymer has a heat of fusion of about 75 J/g or less, melting point of about 120° C. or less, and crystallinity of about 2% to about 65% of isotactic polypropylene.
   32. A method for forming a multilayer composite comprising the steps of:
(a) producing a first layer using a first die;
(b) producing a second layer using a second die;
(c) providing a ridged first collecting surface positioned to collect the first layer and a ridged second collecting surface positioned to collect the second layer, wherein the first and second ridged collecting surfaces create a nip;
(d) passing the first layer and the second layer through the nip; and
(e) forming a multilayer composite.
   33. A method for forming a multilayer composite comprising the steps of:
(a) producing a first layer using a first die;
(b) producing a second layer using a second die;
(c) producing an intermediate layer using an intermediate die;
(d) providing a ridged collecting surface positioned to collect the first layer, the second layer, and the intermediate layer to form a multilayer composite wherein the intermediate layer is between the first layer and the second layer; and
(e) forming the multilayer composite.
   34. A multilayer composite comprising:
(a) a ridged first layer having an allowable elongation of at least about 20%;
(b) an intermediate layer comprising an elastic resin; and
(c) a ridged second layer having an allowable elongation of at least about 20%,
wherein the intermediate layer is between the ridged first layer and the ridged second layer.
   35. The multilayer composite of paragraph 34, wherein the elastic resin comprises a propylene-alpha-olefin copolymer comprising: (i) at least about 50 wt % of the propylene-alpha-olefin copolymer, of propylene-derived units; and (ii) about 5 wt % to about 35 wt % of the propylene-alpha-olefin copolymer, of units derived from at least one of ethylene and a C₄-C₁₀ alpha-olefin, wherein the polypropylene-alpha-olefin copolymer has a heat of fusion of about 75 J/g or less, melting point of about 120° C. or less, and crystallinity of about 2% to about 65% of isotactic polypropylene.
   36. The multilayer composite of paragraph 34, wherein at least one of the ridged first layer and the ridged second layer has an average peak-to-valley vertical distance of at least about 2 mm.
   37. The multilayer composite of paragraph 34, wherein at least one of the ridged first layer and the ridged second layer has an average peak-to-valley vertical distance of about 2 mm to about 12 mm.
   38. The multilayer composite of paragraph 34, wherein at least one of the ridged first layer and the ridged second layer has an allowable elongation of at least about 50%.
   39. The multilayer composite of paragraph 34, wherein at least one of the ridged first layer and the ridged second layer has an allowable elongation of at least about 100%.
   40. The multilayer composite of paragraph 34, wherein at least one of the ridged first layer and the ridged second layer has an allowable elongation of at least about 200%.
   41. The multilayer composite of paragraph 34, wherein the ridged first layer and the ridged second layer each have an allowable elongation of at least about 200%.
   42. The multilayer composite of paragraph 34, wherein at least one of the ridged first layer and the ridged second layer comprises at least one of polypropylene and poly(ethylene terephthalate).
   43. The multilayer composite of paragraph 34, wherein the ridged first layer comprises at least one of polypropylene and poly(ethylene terephthalate), and the ridged second layer comprises a polyalphaolefin having a pour point of −10° C. or less and a kinematic viscosity at 100° C. (KV100° C.) of 3 cSt or more.
   44. A method for forming a multilayer composite comprising the steps of:
(a) providing a ridged first layer having an allowable elongation of at least about 20%;
(b) providing an intermediate layer comprising an elastic resin;
(c) providing a ridged second layer having an allowable elongation of at least about 20%; and
(d) contacting the intermediate layer with the ridged first layer and the ridged second layer to form a multilayer composite, wherein the intermediate layer is between the ridged first layer and the ridged second layer.
   45. The method of paragraph 44, wherein the elastic resin comprises a propylene-alpha-olefin copolymer comprising: (i) at least about 50 wt % of the propylene-alpha-olefin copolymer, of propylene-derived units; and (ii) about 5 wt % to about 35 wt % of the propylene-alpha-olefin copolymer, of units derived from at least one of ethylene and a C₄-C₁₀ alpha-olefin, wherein the polypropylene-alpha-olefin copolymer has a heat of fusion of about 75 J/g or less, melting point of about 120° C. or less, and crystallinity of about 2% to about 65% of isotactic polypropylene.
   46. The method of paragraph 44, wherein at least one of the ridged first layer, ridged second layer, and the intermediate layer is meltblown.
   47. The method of paragraph 44, wherein the intermediate layer is meltblown.

1. An apparatus for making a multilayer composite, comprising:
a first extruder;
a first die connected to the first extruder for producing a first layer;
a second extruder;
a second die connected to the second extruder for producing a second layer;
an intermediate extruder;
an intermediate die connected to the intermediate extruder for producing an intermediate layer and positioned such that the intermediate layer is between the first and second layers;
a first collecting surface positioned to collect the first layer; and
a second collecting surface positioned to collect the second layer,
wherein the first and second collecting surfaces create a nip through which the first layer, the second layer, and the intermediate layer are passed to form a multilayer composite, and
wherein at least one of the first and second collecting surfaces is ridged.

2. The apparatus of claim 1, wherein the first and second collecting surfaces are ridged.

3. The apparatus of claim 2, wherein at least one of the first and second collecting surfaces has an average peak-to-valley vertical distance of at least about 2 mm.

4. The apparatus of claim 2, wherein the first and second collecting surfaces are out of phase with one another or in the female-female configuration.

5. The apparatus of claim 2, wherein at least one of the first and second collecting surfaces have ridges in a flattened-tip shape.

6. The apparatus of claim 1, further comprising a third extruder and a third die for producing a third layer, wherein the third die is connected to the third extruder and positioned such that the first layer, the second layer, the third layer, and the intermediate layer pass through the nip to form a multilayer composite.

7. The apparatus of claim 6, further comprising a fourth extruder and a fourth die for producing a fourth layer, wherein the fourth die is connected to the fourth extruder and positioned such that the first layer, the second layer, the third layer, the fourth layer, and the intermediate layer pass through the nip to form a multilayer composite.

8. The apparatus of claim 1, wherein the first and second collecting surfaces are counter-rotating drums.

9. The apparatus of claim 1, wherein at least one of the first and second collecting surfaces is a series of parallel plates forming ridges.

10. The apparatus of claim 1, wherein at least one of the first and second collecting surfaces is a rod having a series of vanes forming ridges.

11. (canceled)

12. An apparatus for making a multilayer composite, comprising:
a first extruder;
a first die connected to the first extruder for producing a first layer;
a second extruder;
a second die connected to the second extruder for producing a second layer;
a ridged first collecting surface positioned to collect the first layer; and
a ridged second collecting surface positioned to collect the second layer,
wherein the first and second ridged collecting surfaces create a nip through which the first layer and the second layer are passed to form a multilayer composite.

13. An apparatus for making a multilayer composite, comprising:
a first extruder;
a first die connected to the first extruder for producing a first layer;
a second extruder;
a second die connected to the second extruder for producing a second layer;
an intermediate extruder;
an intermediate die connected to the intermediate extruder for producing an intermediate layer and positioned such that the intermediate layer is between the first and second layers; and
a ridged collecting surface positioned to collect the first layer, the second layer, and the intermediate layer to form a multilayer composite.

14. A method for forming a multilayer composite comprising the steps of:
(a) producing a first layer using a first die;
(b) producing a second layer using a second die;
(c) producing an intermediate layer using an intermediate die;
(d) providing a first collecting surface positioned to collect the first layer and a second collecting surface positioned to collect the second layer, wherein the first and second collecting surfaces create a nip, and wherein at least one of the first and second collecting surfaces is ridged;
(e) passing the first layer, the second layer, and the intermediate layer through the nip, wherein the intermediate layer is between the first layer and the second layer; and
(f) forming a multilayer composite.

15. The method of claim 14, wherein the first and second collecting surfaces are ridged.

16. The method of claim 15, wherein at least one of the first and second collecting surfaces provides an allowable elongation of at least about 20% for at least one of the first layer and the second layer.

17.-20. (canceled)
